(19) United States
(12) Patent Application Publication
(10) Pub. No.: US 2012/0305467 A1
(43) Pub. Date: Dec. 6, 2012

(54) AGGLOMERATES OF ADSORBER PARTICLES AND METHODS FOR PRODUCING SUCH ADSORBER PARTICLES

(76) Inventors: Jann-Michael Giebelhausen, Rathenow (DE); Bertram Böhringer, Wuppertal (DE); Sven Fichtner, Brandenburg (DE)

(21) Appl. No.: 13/579,226

(22) PCT Filed: Jan. 24, 2011
(86) PCT No.: PCT/EP2011/000268

§ 371 Date: Aug. 15, 2012

(30) Foreign Application Priority Data
Feb. 15, 2010 (DE) 1020100081108
Jun. 24, 2010 (DE) 1020100249904

(51) Int. Cl. B01J 20/28; B01J 20/26; B01D 39/00; B01J 20/18; B01D 15/00; B01J 20/30; B01J 20/20

(52) U.S. Cl. 210/263; 502/400; 502/402; 502/416; 502/60; 210/502.1

(57) ABSTRACT

The invention relates to an adsorptive system, in particular on the basis of an agglomerate, comprising a plurality of absorber particles, wherein the absorber particles are fixed, in particular adhered, to a binding agent carrier and are combined by means of the binding agent carrier to form the adsorptive system, in particular to form an agglomerate, and wherein the absorber particles have a first particulate adsorption material and a second particulate adsorption material which is different from the first particulate adsorption material.

### CROSS-REFERENCES TO RELATED APPLICATIONS

This application is a National Stage filing of International Application PCT/EP 2011/000268, filed Jan. 24, 2011, claiming priority to German Applications No. DE 10 2010 008 110.8 filed Feb. 15, 2010, and DE 10 2010 024 990.4 filed Jun. 24, 2010, entitled “AGGLOMERATES OF ADSORBER PARTICLES AND METHODS FOR PRODUCING SUCH ADSORBER PARTICLES.” The subject application claims priority to PCT/EP 2011/000268, and to German Applications No. DE 10 2010 008 110.8, and DE 10 2010 024 990.4 and incorporates all by reference herein, in their entirety.

### BACKGROUND OF THE INVENTION

The present invention relates to the field of adsorption filter technology.

The present invention relates especially to an adsorptive system/structures based on agglomerates of different adsorbents, especially adsorbent particles, and to a process for their production and their use.

The present invention further relates to adsorptive molded parts obtainable from the adsorptive system of the present invention or to be more precise from a multiplicity of adsorptive systems/structures of the present invention, and also to a process for their production and their use.

The present invention additionally relates to filters as such in that it relates to filters comprising the adsorptive systems/structures of the present invention, having the different adsorbents, especially adsorbent particles, or the corresponding adsorptive molded parts of the present invention.

To clean or purify fluidic media, especially gases, gas streams or gas mixtures, such as air for example, or alternatively liquids, such as water for example, particulate systems based on corpuscles having specific activity (e.g. adsorbents, ion exchangers, catalysts, etc.) are often used. For instance, the use of adsorbent particles to remove toxic or noxiant substances and odors from gas or air streams or alternatively from liquids is known from the prior art.

The use of loose beddings of the aforementioned corpuscles, particularly in the form of loose granular-bed filters, is the central use form whereby the particles concerned, such as adsorbent particles for example, are brought into contact with the gas or liquid concerned.

Since small particles, such as adsorbent particles for example, provide a larger surface area than larger particles relative to the corpuscle size/diameter, efficiency is, not unexpectedly, better with the comparatively small particles. However, small particles in the form of loose bedding lead to a high pressure drop and, what is more, promote the formation of channels, which entails a certain risk of breakthrough. Therefore, the corpuscle size used in beddings is often merely a compromise, meaning that usually the best corpuscle sizes for the particular application cannot be used. More particularly, the need to achieve economical operating conditions, especially an acceptable pressure drop, often means only comparatively large particles (e.g., adsorbent particles) come to be used that would be desirable for optimum utilization of the adsorption efficiency, so that it is often the case that a considerable portion of the theoretically available capacity cannot be utilized.

DE 38 13 564 A1 and the same patent family's EP 0 338 551 A2 disclose an activated carbon filter layer for NBC respirators which comprises a highly air-pervious, substantially shape-stable three-dimensional supporting scaffold whereto a layer of granular, especially spherical activated carbon corpuscles from 0.1 to 1 mm in diameter is fixed, wherein the supporting scaffold can be a braided structure formed of wires, monofilaments or struts, or be a large-pore reticulated polyurethane foam. One disadvantage with the system described therein is the fact that it requires an additional supporting material which has to be endowed with the particles in question in a relatively costly and inconvenient operation. In addition, the particular choice of supporting scaffold then limits the use in question.

DE 42 39 520 A1 further discloses a high-performance filter which consists of a three-dimensional supporting scaffold whereto adsorbent corpuscles are fixed via a bonding material, wherein the supporting scaffold is sheathed with a thermally stable and highly hydrolysis-resistant plastic, the weight of which amounts to about 20 to 500% of the weight of the scaffold. More particularly, the supporting scaffold is a large-pore reticulated polyurethane foam sheathed with a silicone resin, polypropylene, hydrolysis-resistant polyurethane, an acrylate, a synthetic rubber or fluoropolymers. The operation to produce these structures is relatively costly and inconvenient. In addition, the technology described therein requires the presence of an additional supporting structure.

DE 43 43 358 A1 further discloses porous bodies comprising activated carbon which consist of plates and agglomerates formed from ground activated carbon incorporated in a porous SiO₂ matrix. What is more particularly described therein are porous plates or bodies having adsorbing properties, wherein activated carbon granules or activated carbon spherules, or to be more precise, granules or spherules comprising activated carbon, are adhered together by means of a silicate solution and subsequently the silicate bridges are converted into silica gel bridges and the bodies are dried. One disadvantage with this is the fixed geometry of these porous bodies and also their lack of flexibility and compressibility, making them unsuitable for filtering conditions under mechanical loading. A further disadvantage is that the particles comprising activated carbon are completely wetted by the silicate solution and so a large portion of the capacity of these particles is no longer available for adsorptive processes.

DE 43 31 586 C2 similarly discloses activated carbon agglomerates wherein activated carbon corpuscles between 0.1 to 5 mm in diameter are disposed and adhered around an approximately equal-sized corpuscle of pitch by slight pressure and heating and thereafter the pitch corpuscle is rendered infusible and converted into activated carbon by oxidation, so that the free interspace between the corpuscles in the agglomerate has a width amounting to at least 10% by volume of the corpuscle size. One disadvantage with the corpuscles described therein is the relatively costly, high-energy production process and also the incompressibility of the agglomerates obtained. Owing to the rigidity of the activated carbon agglomerates, no use is contemplated for filter applications under mechanical loading. The lack of compressibility also means that further processing into molded parts by compression molding is not possible.

The same applies to the porous bodies having adsorbing properties as per DE 42 38 142 A1, which comprise adsorbent corpuscles which are interconnected via bridges of inorganic material, especially argillaceous earth, wherein the void spaces between the adsorbent corpuscles comprise from 10 to 100% of the volume of the adsorbent corpuscles. Again, the porous bodies described therein have merely little flexibility and compressibility, foreclosing any use under mechanical loading and any further processing into molded parts by compression molding.

Furthermore, the commonly assigned German patent application DE 10 2008 058 249.2, filed 19 Nov. 2008, relates to adsorptive structures based on agglomerates of adsorbent particles, wherein adsorbent particles identical in molding/shaping are bound together via a thermoplastic binder. Agglomerates of this type are already sufficient as a basis for providing capable adsorption materials which, in a granular bed especially, have distinctly reduced pressure differences compared with when the purely adsorbent particles are used as a basis, so that very good flow-through behavior can be realized in agglomerates of this type. However, the surface area of the adsorptive structures which is formed by the thermoplastic polymer is occasionally not fully occupied by adsorbent particles, so that nonadsorptive surfaces are present to a certain degree in respect of the adsorptive structure.

Against this technical background, therefore, the present invention has for its object to provide adsorptive systems/molded parts on the basis of agglomerates which at least largely avoid or alternatively at least ameliorate the above-described disadvantages of the prior art.

### BRIEF SUMMARY OF THE INVENTION

The present invention more particularly has for its object to provide adsorptive systems/molded parts which on the one hand avoid or at least ameliorate the disadvantages of conventional granular-bed filters based on distinct particles present in loose bedding. In addition, on the other hand, further improvement in adsorptive properties not only in respect of the adsorption capacity but also in respect of the adsorption spectrum shall be realized especially with a view to custom tailoring the adsorptive properties to the type/nature of substances to be adsorbed.

The present invention further has for its object to further develop the systems described in the above-cited DE 10 2008 058 249.2 document and to improve these systems especially as regards the adsorption capacity and the adsorption spectrum in that a multiplicity of different substances shall be efficiently adsorbed using one and the same material.

The present invention yet further has for its object to provide adsorptive systems and adsorptive molded parts which contain or consist of the systems of the present invention and which moreover also enable use under high mechanical loading, especially with a view to providing sufficient flexibility/compressibility on the part of the adsorptive systems of the present invention to enable their further processing into adsorptive molded parts.

The stated object is achieved, in accordance with the present invention, which relates to the adsorptive system of the present invention by using a first particulate adsorption material (A) and a different second particulate adsorption material (B); further, advantageous developments and incarnations of this aspect of the present invention are described herein.

The present invention further provides the processes of the present invention for producing the adsorptive system according to the invention and as the subject matter of corresponding independent process claims. Further, advantageous developments and incarnations of this aspect of the present invention are described herein.

The present invention further provides for the uses of the adsorptive system according to the present invention as are defined herein.

The present invention likewise provides a filter, wherein the filter of the present invention contains the adsorptive systems according to the invention; further advantageous developments and incarnations of the filter of the present invention are similarly provided.

The present invention further provides the molded part according to the invention and also the process for producing the adsorptive molded part of the present invention and its use and also filters comprising the adsorptive molded parts according to the invention, as described herein.

It will be readily understood that incarnations, embodiments, advantages and the like, as recited hereinbelow in respect of one aspect of the present invention only for the avoidance of repetition, self-evidently also apply mutatis mutandis to the other aspects of the present invention.

It will further be readily understood that the ranges recited hereinbelow for value, number and range recitations are not to be construed as limiting; a person skilled in the art would appreciate that in a particular case or for a particular use, departures from the recited ranges and particulars are possible without leaving the realm of the present invention.

In addition, any hereinbelow recited value/parameter recitations or the like can in principle be determined/ascertained using standardized or explicitly recited methods of determination or else using methods of determination which are per se familiar to a person skilled in the art.

Having made that clear, the present invention will now be more particularly described.

### BRIEF DESCRIPTION OF THE DRAWINGS

FIG. 1A shows a schematic cross-sectional depiction of an inventive adsorptive system with adsorbents fixed to a binder carrier which are in the form of a first particulate adsorption material (A) and a second particulate adsorption material (B);

FIG. 1B shows a schematic plan view of an inventive adsorptive system with adsorbents applied atop a binder carrier which are in the form of a first particulate adsorption material (A) and a second particulate adsorption material (B);

FIG. 1C shows a magnified photographic depiction of an inventive adsorptive system with fixed adsorbents in the form of a first particulate adsorption material (A) and a second particulate adsorption material (B);

FIG. 1D shows a magnified photographic depiction of a further adsorptive system according to the invention with an applied first particulate adsorption material (A) and a second particulate adsorption material (B);

FIG. 1E shows a magnified photographic depiction of a multiplicity of inventive adsorptive systems, wherein the individual adsorptive systems according to the invention each include a first particulate adsorption material (A) and also a second particulate adsorption material (B);

FIG. 2A shows a schematic cross-sectional depiction of the inventive adsorptive system in a further embodiment of the present invention wherein the adsorptive system includes a first particulate adsorption material (A′) and a second particulate adsorption material (B′) which are each secured to a binder carrier;

FIG. 2B shows a schematic plan view of an inventive adsorptive system in a further embodiment of the present invention with a first particulate adsorption material (A′) and a second particulate adsorption material (B′);

FIG. 3A shows a schematic depiction of the inventive process in a first embodiment of the present invention for producing the adsorptive systems of the present invention;

FIG. 3B shows a schematic depiction of the inventive process for producing the adsorptive systems according to the invention in a further embodiment.

### DETAILED DESCRIPTION OF THE INVENTION

The present invention accordingly provides—in accordance with a first aspect of the present invention—an adsorptive system, especially agglomerate based, having a multiplicity of adsorbent particles (A, B),
wherein the adsorbent particles (A, B) are fixed, especially adhered, on a binder carrier and are bound together via the binder carrier into the adsorptive system, especially into an agglomerate, and
wherein the adsorbent particles (A, B) include a first particulate adsorption material and a second particulate adsorption material (B) other than the first particulate adsorption material (A).

The term “adsorptive system” or “agglomerates” which is used in the realm of the present invention is to be understood as having a very broad meaning, and more particularly designates a more or less consolidated/conjoined accumulation of previously loose/distinct constituents (i.e., individual adsorbent particles or, respectively, individual corpuscles of the respective particulate adsorption material (A) and (B)) to form a more or less firm ensemble. The term in the realm of the present invention also designates so to speak technically produced conglomerations/accumulations of individual adsorbent particles which are conjoined together in the present case by an especially organic polymer/binder.

The term “adsorptive system” or “agglomerate” similarly designates in the realm of the present invention so to speak a technically produced conglomeration/accumulation of individual adsorbent particles, wherein at least two different adsorbent particles (A) and (B) are used in the realm of the present invention, and they are conjoined/held together by a binder. In other words, the position is such in the realm of the adsorptive systems of the present invention that the respective adsorbent particles of mutually different adsorption materials (A) and (B) are bound together via a binder in respect of any individual adsorptive system or, respectively, any individual agglomerate. The respective particulate and thus especially corpuscle-shaped adsorption materials are attached/secured/fixed/adhered/bonded to the surface of the binder carrier.

It is accordingly the case that the term “adsorptive system” or “agglomerate” as used in the realm of the present invention focuses especially on a functional totality of constituents formed especially by mutually different particulate adsorption materials (A) and (B) on the one hand and the binder carrier on the other, wherein the individual constituents relate to and interact with each or one another such that they can be regarded as one dedicated unit. Therefore, the term “adsorptive system” or “agglomerate” as used in the present invention is directed at a formation/unit/structure or to an assembly of different constituents which form one coherent body or structure.

Accordingly, the adsorptive systems of the present invention are self-supporting as it were, especially in that the respective particulate units are secured/fixed to the binder carrier in the form of particulate adsorption materials (A) and (B).

As will be further developed hereinbelow, the adsorptive system of the present invention is not limited to the use of two different particulate adsorption materials (A) and (B). On the contrary, in the realm of the present invention, it is possible for the adsorptive system according to the invention to additionally comprise further particulate adsorption materials (C), (D), (E), etc., especially with the proviso that the respective adsorption materials (C), (D), (E), etc. are different than not only one another but in particular also than the particulate adsorption materials (A) and (B).

The present invention thus determinatively focuses on the use of mutually different particulate adsorption materials in respect of the adsorptive system/unit according to the invention, providing in effect one functional unit with different adsorption materials. This means that the present invention has very surprisingly succeeded in providing adsorptive systems in the manner of a functional assembly/formation which have distinctly improved properties over the prior art.

This is because the adsorptive systems of the present invention, by permitting selection and coordination of the respective particulate adsorption materials (A) and (B), can be custom tailored/optimized in respect of this particular intended use, especially as regards specific adaptation against the background of the particular character of the substances to be adsorbed.

For example, an optimization regarding the adsorption of polar and apolar substances alike in one and the same material can be realized on the basis of the present invention. The combination of two or more mutually different particulate adsorption materials and/or different types of adsorbents thus makes it possible to achieve an improved/enhanced breadth/functionality and hence of the adsorption spectrum of the resulting adsorptive system—and this at a comparably low pressure drop in beddings compared with the respective base agglomerates/systems. In addition the surface occupancy of the binder carrier has been optimized, which further increases the adsorption capacity, as will be further described hereinbelow.

A key idea of the present invention consists in making the respective particulate adsorption materials (A) and (B) mutually different such that the particulate adsorption materials (A) and (B) have mutually different corpuscle sizes/diameters. This concept of the present invention has the very surprising consequence that the surface formed by the binder carrier can be optimally covered with or occupied by the particulate adsorption materials, so that in effect at least essentially the entire surface area of the binder carrier is covered with the respective particulate adsorption materials. This leads to a far-reaching increase in adsorption capability, since the amount or volume of adsorption-capable material in the adsorptive system according to the invention is altogether larger. This is because—without wishing to be tied to this theory—the particulate adsorption materials have a comparatively large corpuscle diameter/size on the one hand and the particulate adsorption materials having the lower corpuscle diameter/size on the other complement each other optimally in that the comparatively small particulate adsorption materials can optimally occupy/cover the area/space on the binder carrier between the comparatively large particulate adsorption materials, so that almost the entire surface area of the binder carrier is occupied by the respective particulate structures.

In the realm of the present invention, therefore, the aspect of the differing size-based harmonization between the respective particulate adsorption materials (A) and (B) can be used to realize a distinct increase in the surface area/volume ratio of the composite adsorbent or of the adsorptive system according to the invention, compared with the respective base agglomerates/particles, which leads to an increased adsorption capability/performance on the part of the adsorptive system of the present invention. As far as the abovementioned ratio is concerned, the surface area relates to the areas of the agglomerate which are capable of adsorption. This must be regarded as a further decisive advantage of the present invention.

However, the present invention is not restricted to a difference in the respective corpuscle sizes:

This is because it can be generally provided in the realm of the present invention that the first particulate adsorption material (A) and the second particulate adsorption material (B) have at least one mutually different physical and/or chemical property, especially at least one mutually different physical and/or chemical parameter.

In this context, the term “physical property” or “physical parameter” as used in the present invention relates especially to the three-dimensional structure/configuration of respective adsorption materials (A) and/or (B), especially for example to the shaping, the corpuscle size and/or the corpuscle diameter. The physical properties/parameters of adsorption materials used according to the present invention can also include for example properties relating to the porosity of respective adsorption materials (A) and/or (B), for example the pore volume, the BET surface area and the like. The terms “chemical properties” and “chemical parameters”, by contrast, relate especially to properties relating to the chemical character of adsorption materials (A) and/or (B) used according to the present invention, for example the chemical structure of the substance- or mass-forming material of adsorption materials used. In general, however, the aforementioned terms cannot be separated strictly from each or one another in the realm of the present invention. For instance, the chemical character of the substance- or mass-forming material can have an effect on porosity, and this fact can influence for example the adsorption behavior of adsorption materials used, so that physical and chemical parameters can in effect be mutually dependent and/or necessitate each other.

As regards the differing development of at least one physical and/or chemical parameter/property on the part of the respective particulate adsorption material (A) and (B), it can be provided in the realm of the present invention that the employed particulate adsorption materials (A) and (B) are identical as regards their chemical character, or in respect of the selection/nature of the substance- or mass-forming materials, in which case the employed particulate adsorption materials (A) and (B) then mutually differ in at least one further parameter, for example a physical parameter. It can accordingly be provided in the realm of the present invention that both the particulate adsorption materials (A) and (B) are formed on the basis of activated carbon, in which case the respective corpuscles/particles of the corresponding adsorption materials (A) and (B) can have mutually different corpuscle sizes/diameters. As mentioned, the employed particulate adsorption materials (A) and (B) can then also further differ for example as regards their porosity, their pore volume distribution or the like.

It can further also be possible in the realm of the present invention for the employed particulate adsorption materials (A) and (B) to have a differing chemical structure/nature on the part of the substance- or mass-forming material. It is then also possible in this respect that the employed adsorption materials (A) and (B) do not differ in the other properties essentially at least.

However, even when particulate adsorption materials (A) and (B) which differ in chemical character/structure are used, it is also possible for further parameters also to differ from each or one another. In this context, it can be provided in the realm of the present invention that, for example, the first particulate adsorption material (A) is used in the form of activated carbon, while the second particulate adsorption material (B)—for example and as will be more particularly described hereinbelow—can be selected from the group of zeolites, molecular sieves, metal oxide and/or metal particles, ion exchanger resins, inorganic oxides, porous organic polymers and/or porous organic-inorganic hybrid polymers and/or organometallic scaffolding materials, such as MOFs (Metall Organic Framework), mineral pellets and clathrates and also their mixtures and/or combinations. For example, comparable corpuscle sizes/diameters but also mutually different corpuscle sizes/diameters can be realized here for the respective particulate adsorption materials (A) and (B). For instance, the first particulate adsorption material (A) can be a particulate activated carbon having a larger corpuscle diameter/size than the second particulate adsorption material (B), and the above-described materials can be used for the second particulate adsorption material (B), which then can have a smaller corpuscle diameter/size compared with the first particulate adsorption material (A).

Therefore, the targeted selection and harmonization of mutually different particulate adsorption materials (A) and (B) in respect of the adsorptive system according to the invention results in the decisive advantage that, on the one hand, the performance capability of the adsorptive system according to the invention can be altogether increased, especially as regards an increase in adsorption capacity due to complete occupancy of the surface area of the binder carrier, while, on the other hand, the differentiated configuration of the respective particulate adsorption materials (A) and (B), for example in the form of activated carbon for one and MOFs for the other, can be used to custom tailor/optimize the adsorption specificity/spectrum. For instance, activated carbon is useful for adsorbing organic substances, while MOFs are useful for adsorbing other gases, such as NH₃. The specific combination of activated carbon and MOFs then endows the resulting agglomerate of the present invention with both properties in one and the same system.

The physical and/or chemical property, especially the physical and/or chemical parameter can generally be selected in the realm of the present invention from the group of (i) corpuscle size, especially average corpuscle size, and/or corpuscle diameter, especially average corpuscle diameter D50; (ii) specific surface area, especially BET surface area; (iii) pore volume, especially adsorption volume and/or total pore volume; (iv) porosity and/or pore distribution, especially micropore volume fraction of total pore volume and/or average pore diameter; (v) corpuscle shape; (vi) chemical nature of particle-forming material; (vii) impregnation and/or catalytic additization; and also (viii) combinations of two or more of these properties.

More particularly, it can be provided in the realm of the present invention that the corpuscles and/or particles of the first particulate adsorption material (A) are fixed onto the binder carrier and bound together via the binder carrier to form the adsorptive system according to the invention. It is more particularly advantageous in this respect when free regions of the binder carrier which remain between the corpuscles and/or particles of the first particulate adsorption material (A) are endowed with corpuscles and/or particles of the second particulate adsorption material (B). In accordance with the concept of the present invention, therefore, the corpuscles/particles of the second particulate adsorption material (B) are fixed to the binder carrier, especially such that the corpuscles/particles of the second adsorption material (B) are disposed in those regions of the surface of the binder carrier which are not occupied by the corpuscles/particles of the first particulate adsorption material (A). In other words, the corpuscles/particles of the second particulate adsorption material (B) can occupy the interspace formed by the corpuscles/particles of the first particulate adsorption material (A), and be applied/fixed on the binder carrier in this regard. This results in the above-described optimum utilization/occupancy of the surface area of the binder carrier.

In an embodiment of the present invention that is particularly preferred according to the present invention, the first particulate adsorption material (A) and the second particulate adsorption material (B) can have mutually different corpuscle sizes, especially mutually different corpuscle diameters. The corpuscle size and diameter in question can be the absolute corpuscle size or, respectively, the absolute corpuscle diameter, or alternatively the average corpuscle size or, respectively, the average corpuscle diameter D50. The appropriate corpuscle sizes and diameters can be determined on the basis of the method of ASTM D2862-97/04 for example. In addition, the aforementioned quantities can be determined using further determinations based on a sieve analysis, based on x-ray diffraction, laser diffractometry or the like. The particular methods of determination are as such well known to a person skilled in the art, so that no further exposition is required in this regard.

The size distribution can be more particularly monodisperse or preferably polydisperse. In the event of different average corpuscle sizes/diameters for the respective adsorption materials (A) and (B), the size distribution can also overlap at the respective edge regions, i.e., the largest corpuscles of one corpuscle variety can come within the region of the smallest corpuscles of the other corpuscle variety, and vice versa.

In this context, it can be provided according to the present invention that the corpuscle size, especially the corpuscle diameter, and/or the average corpuscle diameter, especially the average corpuscle diameter D50, of the first particulate adsorption material (A) on the one hand and/or the corpuscle size, especially the corpuscle diameter, and/or the average corpuscle diameter, especially the average corpuscle diameter D50, of the second particulate adsorption material (B), on the other, are selected such that the corpuscles and/or particles of the second particulate adsorption material (B) are disposed on the binder carrier between the corpuscles/particles of the first particulate adsorption material (A), and/or such that free regions of the binder carrier which remain between the corpuscles and/or particles of the first particulate adsorption material (A) are endowed with corpuscles and/or particles of the second particulate adsorption material (B).

In other words, the corpuscles/particles of the second particulate adsorption material (B) act as it were as gapfillers which occupy the free regions on the surface of the binder carrier between the first particulate adsorption material (A). This achieves, as mentioned, optimal utilization of the available area to fix adsorbents on the binder carrier, leading to the above-described outstanding adsorption performances with the additional possibility of goal-directed custom tailoring of adsorption properties.

In a particular embodiment of the present invention, the first particulate adsorption material (A) can have a larger corpuscle size, especially a larger corpuscle diameter, and/or a larger average corpuscle diameter, especially larger average corpuscle diameter D50, than the second particulate adsorption material (B). However, it is similarly conceivable in the realm of the present invention for the first particulate adsorption material (A) to have smaller values than the second particulate adsorption material (B) in respect of the aforementioned corpuscle sizes/diameters. In this case, then, the first particulate adsorption material (A) acts so to speak as a gapfiller in relation to the surface of the binder carrier.

In an advantageous embodiment of the present invention, the first particulate adsorption material (A) and the second particulate adsorption material (B) have mutually different corpuscle sizes, especially mutually different corpuscle diameters, wherein the corpuscle sizes, especially the corpuscle diameters, especially the average corpuscle diameters, of the first particulate adsorption material (A) on the one hand and of the second particulate adsorption material (B) on the other mutually differ by at least a factor of 1.1, especially at least a factor of 1.25, preferably at least a factor of 1.5, more preferably at least a factor of 2, even more preferably at least a factor of 5 and yet even more preferably at least a factor of 10, all based on the smaller corpuscle size value. In the context it can also be provided that the corpuscle sizes, especially the corpuscle diameters, especially the average corpuscle diameters, of the first particulate adsorption material (A) on the one hand and/or of the second particulate adsorption material (B) on the other differ by at least 0.001 mm, especially by at least 0.01 mm, preferably by at least 0.05 mm and more preferably by at least 0.1 mm, especially with the proviso that the first particulate adsorption material (A) has the larger values and/or especially with the proviso that the second particulate adsorption material (B) has the smaller values.

In a similarly advantageous embodiment of the present invention, the corpuscle size, especially the corpuscle diameter, and/or the average corpuscle diameter, especially the average corpuscle diameter D50, of the first particulate adsorption material (A) is by at least a factor of 1.1, especially at least a factor of 1.25, preferably at least a factor of 1.5, more preferably at least a factor of 2, even more preferably at least a factor of 5, indeed even more preferably at least a factor of 10 greater than the corpuscle size, especially the corpuscle diameter, and/or the average corpuscle diameter, especially the average corpuscle diameter D50, of the second particulate adsorption material (B).

It can also be provided in the realm of the present invention that the ratio of the corpuscle size, especially of the corpuscle diameter, and/or of the average corpuscle diameter, especially of the average corpuscle diameter D50, of the first particulate adsorption material (A) to the corpuscle size, especially the corpuscle diameter, and/or to the average corpuscle diameter, especially the average corpuscle diameter D50, of the second particulate adsorption material (B) is at least 1.1:1, especially at least 1.25:1, preferably at least 1.5:1, more preferably at least 2:1, even more preferably at least 5:1 and yet even more preferably at least 10:1.

The aforementioned ratio is the ratio of the corpuscle size of the first particulate adsorption material (A) to the corpuscle size of the second particulate adsorption material (B) (corpuscle size of the first particulate adsorption material (A):corpuscle size of the second particulate adsorption material (B)).

It can also be provided according to the present invention that the ratio of the corpuscle size, especially of the corpuscle diameter, and/or of the average corpuscle diameter, especially of the average corpuscle diameter D50, of the first particulate adsorption material (A) to the corpuscle size, especially the corpuscle diameter, and/or to the average corpuscle diameter, especially the average corpuscle diameter D50, of the second particulate adsorption material (B) is in the range from 1.1:1 to 200:1, especially in the range from 1.25:1 to 100:1, preferably in the range from 1.5:1 to 75:1, more preferably in the range from 2:1 to 50:1, even more preferably in the range from 3:1 to 30:1 and yet even more preferably in the range from 5:1 to 15:1.

It can further be provided in relation to the respective corpuscle sizes of the particulate adsorption materials (A) and (B) used in the realm of the present invention, that the first particulate adsorption material (A) has corpuscle sizes, especially corpuscle diameters, of at least 0.01 mm, especially at least 0.05 mm, preferably at least 0.1 mm, more preferably at least 0.2 mm and even more preferably at least 0.5 mm. In addition the first particulate adsorption material (A) can have corpuscle sizes, especially corpuscle diameters, in the range from 0.01 to 5 mm, especially in the range from 0.05 to 3 mm, preferably in the range from 0.1 to 2 mm, more preferably in the range from 0.2 to 1.5 mm and even more preferably in the range from 0.5 to 1 mm. The abovementioned size recitations in this case apply especially in each case with the proviso that the corpuscle sizes, especially the corpuscle diameters, of the first particulate adsorption material (A) are larger than the corpuscle sizes, especially the corpuscle diameters, of the second particulate adsorption material (B), and/or with the proviso that the corpuscle sizes, especially the corpuscle diameters, of the second particulate adsorption material (B) are smaller than the corpuscle sizes, especially the corpuscle diameters, of the first particulate adsorption material (A).

As far as the absolute size values in respect of the second particulate adsorption material (B) are concerned, it has been found advantageous in the realm of the present invention when the second particulate adsorption material (B) has corpuscle sizes, especially corpuscle diameters, of at most 2 mm, especially at most 1 mm, preferably at most 0.5 mm, more preferably at most 0.3 mm and even more preferably at most 0.2 mm, and/or when the second particulate adsorption material (B) has corpuscle sizes, especially corpuscle diameters, in the range from 0.001 to 2 mm, especially in the range from 0.005 to 1.5 mm, preferably in the range from 0.01 to 1 mm, even more preferably in the range from 0.05 to 0.75 mm and even more preferably in the range from 0.1 to 0.5 mm. The abovementioned value recitations with respect to the respective corpuscle sizes, especially corpuscle diameters, in respect of the second particulate adsorption material (B) apply especially in each case with the proviso that the corpuscle sizes, especially the corpuscle diameters, of the second particulate adsorption material (B) are smaller than the corpuscle sizes, especially the corpuscle diameters, of the first particulate adsorption material (A), and/or with the proviso that the corpuscle sizes, especially the corpuscle diameters, of the first particulate adsorption material (A) are larger than the corpuscle sizes, especially the corpuscle diameters, of the second particulate adsorption material (B).

It can further be provided in the realm of the present invention, in respect of the particular corpuscle sizes and corpuscle diameters, that the first particulate adsorption material (A) has an average corpuscle size, especially an average corpuscle diameter D50, of at least 0.02 mm, especially at least 0.08 mm, preferably at least 0.01 mm, more preferably at least 0.3 mm and even more preferably at least 0.5 mm. In this connection it can be provided in accordance with the present invention that the first particulate adsorption material (A) has an average corpuscle size, especially an average corpuscle diameter D50, in the range from 0.05 to 4 mm, especially in the range from 0.1 to 2 mm, preferably in the range from 0.15 to 1.5 mm, more preferably in the range from 0.3 to 1.2 mm and even more preferably in the range from 0.5 to 1 mm. The abovementioned value recitations also apply especially in each case with the proviso that the average corpuscle size, especially the average corpuscle diameter D50, of the first particulate adsorption material (A) is larger than the average corpuscle size, especially the average corpuscle diameter D50, of the second particulate adsorption material (B), and/or with the proviso that the average corpuscle size, especially the average corpuscle diameter D50, of the second particulate adsorption material (B) is smaller than the average corpuscle size, especially the average corpuscle diameter D50, of the first particulate adsorption material (A).

The second particulate adsorption material (B) can have an average corpuscle size, especially an average corpuscle diameter D50, of at most 1.8 mm, especially at most 0.8 mm, preferably at most 0.4 mm, more preferably at most 0.2 mm and even more preferably at most 0.1 mm. In this connection the second particulate adsorption material (B) can have an average corpuscle size, especially an average corpuscle diameter D50, in the range from 0.005 to 1.5 mm, especially in the range from 0.01 to 1.2 mm, preferably in the range from 0.02 to 1 mm, more preferably in the range from 0.06 to 0.6 mm and even more preferably in the range from 0.15 to 0.4 mm. The abovementioned value recitations also apply especially in each case with the proviso that the average corpuscle size, especially the average corpuscle diameter D50, of the second particulate adsorption material (B) is smaller than the average corpuscle size, especially the average corpuscle diameter D50, of the first particulate adsorption material (A), and/or with the proviso that the corpuscle size, especially the corpuscle diameter, of the first particulate adsorption material (A) is larger than the corpuscle size, especially the corpuscle diameter, of the second particulate adsorption material (B).

By coordinating the particle sizes of the first and the second particulate adsorption materials (A) and (B), it is thus possible for the overall adsorption efficiency and overall adsorption kinetics of the adsorptive system of the present invention to be adjusted/controlled, especially via specific adjustment of the respective surface/volume ratio in relation to the respective particulate adsorption material (A) or (B). Specific choice and adjustment of particle sizes for the particulate adsorption materials (A) and (B) and also their adjustment relative to each other can further be used to adjust the bulk density and capacity and also the pressure drop on flow through the adsorptive system of the present invention, especially when the adsorptive system according to the invention is used in the form of a loose bed or in the form of molded parts or filters.

As mentioned, the specific size coordination between the respective particulate adsorption materials (A) and (B) achieves optimum occupancy of the surface area of the binder. In addition, the specific combination of particulate adsorbents, for example each based on activated carbon, by the differing development of the respective corpuscle sizes/diameters as defined above, provides for further optimization of adsorption properties such that the resulting adsorptive system according to the invention has not only a very good adsorption spontaneity but also a very high total adsorption. This is because—without wishing to be tied to this theory—adsorbents, especially adsorbents based on activated carbon, which have a comparatively small particle diameter/size have a higher/improved adsorption spontaneity, while corresponding particulate adsorbents having comparatively large particle sizes/diameters generally have an increased total adsorption capacity. Specific combination thus makes it possible to combine the aforementioned properties with each or one another in a positive manner.

As far as the shaping of the employed particulate adsorbents (A) and (B) is concerned, it is advantageous in the realm of the present invention when the first particulate adsorption material (A) and/or the second particulate adsorption material (B) is/are granular, especially spherical. Preferably, the employed particulate adsorption materials (A) and (B) should have an identical shape. It is also possible, however, for the first particulate adsorption material (A) to have a shape other than and/or different from the second particulate adsorption material (B).

In general, the present invention is not restricted to a granular incarnation of the employed particulate adsorption materials (A) and (B), although this embodiment is preferred according to the present invention. In general, use of particulate adsorbents in the form of carbon powder, splint carbon, molded carbon or the like is also suitable for example. Spherical activated carbon, also known by the synonym of “spherocarbon”, has a whole series of advantages over other forms of activated carbon, such as carbon powder, splint carbon and the like, rendering it particularly useful for certain applications. Spherocarbon is free flowing, abrasion-resistant and dustless and hard. The employed particulate adsorption materials (A) and/or (B) may have, independently of each other, a compressive or bursting strength (maximum weight per corpuscle/particle) of at least 5 N, especially a compressive or bursting strength in the range from 5 N to 50 N.

The adsorption properties of the adsorptive system of the present invention can also be—as sole measure or in addition to the further physical and/or chemical properties of the employed particulate adsorption materials (A) and (B)—further optimized/custom tailored by coordinating the specific surface areas (BET surface areas) of the respective particulate adsorption materials (A) and (B) in a specific manner.

Accordingly, in one possible embodiment of the present invention, the first particulate adsorption material (A) and the second particulate adsorption material (B) have mutually different specific surface areas (BET surface areas). In this connection, the respective specific surface areas can differ from each other by at least 10 m²/g, especially by at least 20 m²/g, preferably by at least 50 m²/g, more preferably by at least 100 m²/g and even more preferably by at least 200 m²/g. Moreover the respective specific surface areas can differ from each other in the range from 10 to 3500 m²/g, especially in the range from 20 to 3000 m²/g, preferably in the range from 100 to 2500 m²/g and more preferably in the range from 200 to 2000 m²/g.

Typically, the first particulate adsorption material (A) and the second particulate adsorption material (B) can have independently of each other a specific surface area (BET surface area) of at least 500 m²/g, especially at least 750 m²/g, preferably at least 1000 m²/g and more preferably at least 1200 m²/g. Furthermore, typically, the first particulate adsorption material (A) and/or the second particulate adsorption material (B) can have independently of each other a specific surface area (BET surface area) in the range from 500 to 4000 m²/g, especially in the range from 750 to 3000 m²/g, preferably in the range from 900 to 2500 m²/g and more preferably in the range from 950 to 2000 m²/g. The aforementioned particulars regarding the specific surface area (BET surface area) apply especially with the proviso that the first particulate adsorption material (A) and the second particulate adsorption material (B) have mutually different specific surface areas (BET surface areas).

Determining the specific surface area by the BET method is in principle known as such to the person skilled in the art. All BET surface area recitations relate to the determination as per ASTM D6556-04. In the realm of the present invention, the BET surface area is determined in particular using the so-called MultiPoint BET method of determination (MP-BET) in a partial pressure range p/p₀ of 0.05 to 0.1.

With regard to further details concerning the determination of BET surface area and/or the BET method, reference can be made to the aforementioned ASTM D6556-04 and also to Römpp Chemielexikon, 10th edition, Georg Thieme Verlag, Stuttgart/New York, headword: “BET-Methode”, including the references cited therein, and to Winnacker-Küchler (3^{rd} edition), volume 7, pages 93 ff. and also to Z. Anal. Chem. 238, pages 187 to 193 (1968).

In a further embodiment of the present invention, the first particulate adsorption material (A) and the second particulate adsorption material (B) can have mutually different adsorption volumes V_{ads}, especially wherein the respective adsorption volumes V_{ads} mutually differ by at least 1 cm³/g, especially at least 5 cm³/g, preferably at least 10 cm³/g, and more preferably at least 20 cm³/g, and/or especially wherein the respective adsorption volumes V_{ads} mutually differ in the range from 1 to 2500 cm³/g, especially 10 to 2000 cm³/g and preferably 20 to 1500 cm³/g.

Typically, the first particulate adsorption material (A) and/or the second particulate adsorption material (B) can have independently of each other an adsorption volume V_{ads} of at least 250 cm³/g, especially at least 300 cm³/g, preferably at least 350 cm³/g and more preferably at least 400 cm³/g. In addition the first particulate adsorption material (A) and/or the second particulate adsorption material (B) can have independently of each other an adsorption volume V_{ads} in the range from 250 to 3000 cm³/g, especially 300 to 2000 cm³/g and preferably 350 to 2500 cm³/g. The aforementioned value recitations concerning the adsorption volume V_{ads} apply especially with the proviso that the first particulate adsorption material (A) and the second particulate adsorption material (B) have mutually different adsorption volumes V_{ads}.

The adsorption volume V_{ads} is well known to a person skilled in the art as a quantity to characterize the particulate adsorption materials used. The methods of determination in this regard are also well known per se to a person skilled in the art. More particularly, the adsorption volume V_{ads} is the weight-specific adsorbed N₂ volume which is generally determined at a partial pressure p/p₀ of 0.995.

It can further be provided according to the concept of the present invention that the Gurvich total pore volumes applicable to the respectively employed particulate adsorption materials (A) and (B) are specifically adjusted/varied.

In a typically possible embodiment in this context, the first particulate adsorption material (A) and the second particulate adsorption material (B) have mutually different Gurvich total pore volumes, especially wherein the respective total pore volumes mutually differ by at least 0.01 cm³/g, especially at least 0.05 cm³/g, preferably at least 0.1 cm³/g, more preferably at least 0.15 cm³/g and even more preferably at least 0.20 cm³/g, and/or especially wherein the respective Gurvich total pore volumes mutually differ in the range from 0.01 to 1.8 cm³/g, especially 0.05 to 1.4 cm³/g, preferably 0.1 to 1 cm³/g and more preferably 0.15 to 0.8 cm³/g.

In a similarly possible embodiment in this regard, the first particulate adsorption material (A) and/or the second particulate adsorption material (B) have independently of each other a Gurvich total pore volume of at least 0.2 cm³/g, especially at least 0.3 cm³/g, preferably at least 0.4 cm³/g, more preferably at least 0.6 cm³/g and even more preferably at least 0.8 cm³/g, and/or the first particulate adsorption material (A) and/or the second particulate adsorption material (B) have independently of each other a Gurvich total pore volume in the range from 0.2 to 2.0 cm³/g, especially 0.3 to 1.5 cm³/g, preferably 0.5 to 1.2 cm³/g and more preferably 0.6 to 1.0 cm³/g, especially with the proviso that the first particulate adsorption material (A) and the second particulate adsorption material (B) have mutually different Gurvich total pore volumes.

As far as the determination of the Gurvich total pore volume is concerned, this is a method of measurement or determination which is known per se to a person skilled in this field. For further details concerning the determination of the Gurvich total pore volume, reference can be made for example to L. Gurvich (1915), J. Phys. Chem. Soc. Russ. 47, 805, and to S. Lowell et al., Characterization of Porous Solids and Powders: Surface Area Pore Size and Density, Kluwer Academic Publishers, Article Technologies Series, pages 111 ff.

It can further be provided in the realm of the present invention that the adsorption behavior of the adsorptive system of the present invention can be custom tailored/controlled via a specific selection of the pore size distribution in respect of the employed particulate adsorption materials (A) and (B). For instance, and without limitation, an activated carbon having a relatively high proportion of macro- and mesopores and hence a correspondingly low proportion of micropores in relation to the total pore volume can be used for the first particulate adsorption material (A), while a microporous activated carbon, i.e., an activated carbon having a high micropore content and hence a correspondingly low contribution of meso- and macropores to total pore volume can be used for the second particulate adsorption material (B). The specific deployment of particulate adsorption materials having different pore distributions can be used to distinctly increase the spectrum in respect of substances to be adsorbed.

Typically, the first particulate adsorption material (A) and the second particulate adsorption material (B) can have mutually different pore size distributions, especially mutually different contributions of macropores, mesopores and micropores to total pore volume, especially to Gurvich total pore volume.

For example, the first particulate adsorption material (A) or the second particulate adsorption material (B), based on the total pore volume, especially on the Gurvich total pore volume, can have a higher contribution by micropores, especially by micropores having pore diameters of ≦30 Å, especially ≦25 Å and preferably ≦20 Å, than the respectively other particulate adsorption material (A) or (B).

In another embodiment which is possible in general, the first particulate adsorption material (A) and the second particulate adsorption material (B), based on the total pore volume, especially the Gurvich total pore volume, have mutually different contributions by micropores, especially by micropores having pore diameters of ≦30 Å, especially ≦25 Å and preferably ≦20 Å.

In a possible embodiment in the realm of the present invention, the respective contributions by micropores, especially by micropores having pore diameters of ≦30 Å, especially ≦25 Å and preferably ≦20 Å, all based on the total pore volume, especially on the Gurvich total pore volume, mutually differ by at least 1%, especially by at least 3%, preferably by at least 5% and more preferably by at least 10%.

Typically, the respective contributions by micropores, especially by micropores having pore diameters of ≦30 Å, especially ≦25 Å and preferably ≦20 Å, based on the total pore volume, especially on the Gurvich total pore volume, can mutually differ in the range from 1% to 65%, especially 3% to 60%, preferably 5% to 50% and more preferably 10% to 45%.

In a particular embodiment in the realm of the present invention, the first particulate adsorption material (A) and/or the second particulate adsorption material (B), independently of each other and in each case based on the total pore volume, especially on the Gurvich total pore volume, have a contribution by micropores, especially by micropores having pore diameters of ≦30 Å, especially ≦25 Å and preferably ≦20 Å, of at least 70%, especially at least 75%, preferably at least 80%, more preferably at least 85% and even more preferably at least 90%. In addition the respectively different particulate adsorption material (A, B), based on the total pore volume, especially on the Gurvich total pore volume, can have a contribution by micropores, especially by micropores having pore diameters of ≦30 Å, especially ≦25 Å and preferably ≦20 Å, of at most 50%, especially at most 45%, preferably at most 40%, more preferably at most 35% and even more preferably at most 30%.

More particularly, the first particulate adsorption material (A) and the second particulate adsorption material (B) can have mutually different total porosities, especially wherein the respective total porosities mutually differ by at least 1%, especially by at least 5%, preferably by at least 10%, more preferably by at least 25% and even more preferably by at least 50%, and/or wherein the respective total porosities mutually differ in the range from 1% to 75%, especially 5% to 50%, preferably 10% to 60% and more preferably 25% to 50%, all based on the total pore volume of the respective particulate adsorption material (A, B).

In a similarly possible embodiment in the realm of the present invention, the first particulate adsorption material (A) and/or the second particulate adsorption material (B), independently of each other and based on the respective total pore volume of the first and/or second particulate adsorption material (A) and (B), each have a total porosity in the range from 10% to 80%, especially 20% to 75% and preferably 25% to 70%, especially with the proviso that the first particulate adsorption material (A) and the second particulate adsorption material (B) have mutually different total porosities.

In a further possible embodiment of the present invention, the second particulate adsorption material (B) has a higher contribution by micropores to total pore volume, especially to Gurvich total pore volume, especially as defined above, compared with the first particulate adsorption material (A).

Owing to the differing pore distribution that is possible according to the present invention, the employed particulate adsorption materials (A) and (B) can have mutually different average pore diameters.

In one accordingly possible embodiment in the realm of the present invention, the first particulate adsorption material (A) and the second particulate adsorption material (B) have mutually different average pore diameters, especially wherein the respective average pore diameters mutually differ by at least 1 Å, especially by at least 2 Å, preferably by at least 5 Å and more preferably by at least 10 Å, and/or especially wherein the respective average pore diameters mutually differ in the range from 1 to 50 Å, especially 2 to 45 Å, preferably 5 to 40 Å and more preferably 10 to 35 Å.

In addition, the first particulate adsorption material (A) or the second particulate adsorption material (B) can have an average pore diameter of at most 26 Å, especially at most 25 Å and preferably at most 24 Å. In this connection the respectively other particulate adsorption material (A) or (B) can have an average pore diameter of at least 31 Å, especially at least 32 Å and preferably at least 33 Å.

Furthermore, the first particulate adsorption material (A) and the second particulate adsorption material (B), independently of each other, can have an average pore diameter in the range from 15 to 30 Å, especially 16 to 26 Å, preferably 17 to 25 Å and more preferably 18 to 24 Å. In this connection the respectively other particulate adsorption material (A) or (B) can have an average pore diameter in the range from 31 to 60 Å, especially 32 to 55 Å, preferably 33 to 45 Å and more preferably 34 to 40 Å.

Typically, the second particulate adsorption material (B) can have a smaller average pore diameter, especially as defined above, compared with the first particulate adsorption material (A).

Similarly, the particulate adsorption materials used according to the present invention may optionally be impregnated and/or catalyst additized, in which case different impregnations, such as a basic impregnation or an acidic impregnation, and/or mutually different catalysts can also be present for the respectively employed particulate adsorption materials (A) and (B), or merely one particulate adsorption material (A) or (B) may be endowed with a corresponding impregnation or, respectively, catalytic activity.

In this context, the particulate adsorption material (A) and/or the second particulate adsorption material (B) may be, each independently, endowed with at least one catalyst, especially via impregnation or some other form of additization, especially wherein the catalyst may include enzymes and/or metal ions, preferably ions of copper, of silver, of cadmium, of platinum, of palladium, of zinc and/or of mercury. The amount of catalyst used in this regard can be in the range from 0.05% to 12% by weight, preferably in the range from 1% to 10% by weight and more preferably in the range from 2% to 8% by weight, based on the weight of the respective particulate adsorption materials (A) and (B). As far as the optional catalytic additization, especially impregnation, of the particulate adsorption material (A) or (B) is concerned, this can be carried out on the basis of phosphoric acid, calium carbonate, trimethanolamine, 2-amino-1,3-propanediol, sulfur or copper salts. In this context, the amount of impregnant, based on the impregnated particles of adsorbent, can be in the range from 0.01% to 15% by weight, especially in the range from 0.05% to 12% by weight and preferably in the range from 5% to 12% by weight. By using different particulate adsorption materials (A) and (B), even the use of incompatible impregnations/catalysts is possible.

The particulate adsorption materials (A) and (B) used in the realm of the adsorptive system of the present invention can consist of/or comprise a multiplicity of materials which form the corresponding corpuscles/particles. In a possible embodiment of the present invention, the particle-forming material of the first particulate adsorption material (A) and/or of the second particulate adsorption material (B), independently of each other, is selected from the group of
(i) activated carbon, especially granular activated carbon, preferably spherical activated carbon and/or especially molded and/or extruded activated carbon and/or pulverulent activated carbon;
(ii) zeolites, especially natural and/or synthetic zeolites;
(iii) molecular sieves, especially zeolitic molecular sieves, synthetic molecular sieves and/or especially synthetic molecular sieves based on carbon, oxides and/or glasses;
(iv) metal oxide and/or metal particles;
(v) ion exchanger resins, especially polydisperse and/or monodisperse cation and/or anion exchangers, especially of the gel type and/or macroporous type;
(vi) inorganic oxides, especially silicas, silica gels and/or aluminas;
(vii) porous organic polymers and/or porous organic-inorganic hybrid polymers and/or organometallic scaffolding materials, especially MOFs (Metall Organic Framework), COFs (Covalent Organic Framework), ZIFs (Zeolithe Imidazolate Framework), POMs (Polymer Organic Material) and/or OFCs;
(viii) mineral pellets;
(ix) clathrates; and also
(x) their mixtures and/or their combinations.

More particularly, the particle-forming material of the first particulate adsorption material (A) and/or the particle-forming material of the second particulate adsorption material (B), independently of each other, can be formed from activated carbon, especially from granular, preferably spherical activated carbon.

The respective particle-forming materials of the particulate adsorption materials (A) and (B) are well known to a person skilled in the art, and can always be selected, and mutually coordinated, by him or her with a view to endowing the adsorptive system of the present invention with specific adsorption properties. Activated carbons useful in the present invention, which can be based on spherical activated carbon in particular, are available for example from Blücher GmbH, Erkrath, Germany, or from Adsor-Tech GmbH, Premnitz, Germany. Reference in relation to the microporous activated carbon which can be used in the present invention can also be made to the commonly assigned European patent application EP 1 918 022 A1 and also to its equivalent US 2008/0107589 A1, the respective disclosure of which is hereby fully incorporated herein by reference.

As far as those adsorption materials useful in the present invention are concerned that are based on metal-organic framework materials, especially MOFs, the underlying MOF materials may include repeating structural units based on at least one metal, especially metal atom or metal ion, on the one hand, and at least one at least bidentate and/or bridging organic ligands on the other. Useful particulate adsorption material (A) or (B) in the realm of the present invention thus also includes, independently of each other, MOF substances which are interchangeably also referred to as MOF materials, porous coordination polymers or the like. Sorbents of this type are generally porous and crystalline. These metal-organic framework materials have a relatively simple modular construction wherein, in general, a multi-nuclear complex acts as crosslinking point/node to which a plurality of multifunctional/multidentate ligands are attached. Metal-organic framework materials are thus porous, generally crystalline materials, especially of well-ordered crystalline structure, which consist of metal-organic complexes with transition metals (e.g., copper, zinc, nickel, cobalt, etc.) as nodes and organic molecules/ligands as connector/linker between the nodes. As far as MOF materials useful in the present invention are concerned, it must be particularly emphasized that, because pore sizes and/or pore size distribution are precisely definable in the course of preparing the metal-organic framework substances, high selectivity is achievable with regard to the sorption behavior, especially with regard to the adsorption behavior, in which case the pore size or pore size distribution can be controlled via the type/size of organic ligands for example.

For further details concerning the MOF materials to be used, reference can be made more particularly to the international patent application WO 2009/056184 A1 and also to the equivalent German patent application DE 10 2008 005 218 A1, the respective disclosure of which is hereby fully incorporated herein by reference.

In one possible embodiment according to the present invention, the first particulate adsorption material (A) and the second particulate adsorption material (B) each include or consist of at least essentially identical particle-forming materials, especially as defined above, especially with the proviso that otherwise the first particulate adsorption material (A) and the second particulate adsorption material (B) differ in at least one physical and/or chemical parameter. In this case the physical and/or chemical parameter can be selected from the group of (i) corpuscle size, especially average corpuscle size and/or corpuscle diameter, especially average corpuscle diameter; (ii) specific surface area, especially BET surface area; (iii) pore volume, especially adsorption volume and/or total pore volume; (iv) porosity and/or pore distribution, especially micropore volume contribution to total pore volume and/or average pore diameter; (v) impregnation and/or catalytic additization; and also (vi) corpuscle shape.

In one more particular embodiment of the present invention, the first particulate adsorption material (A) and the second particulate adsorption material (B) consist of activated carbon. In this case the first particulate adsorption material (A) and the second particulate adsorption material (B) can have different corpuscle sizes and/or different porosities and/or different pore distributions, especially different micropore volume contributions to total pore volume and/or average pore diameter.

In a further, alternative embodiment of the present invention, the first particulate adsorption material (A) and the second particulate adsorption material (B) include or consist of mutually different particle-forming materials, especially as defined above. In this context it can also be provided according to the present invention that the first particulate adsorption material (A) and the second particulate adsorption material (B) differ in at least one further physical and/or chemical parameter, especially wherein the physical and/or chemical parameter is selected from the group of (i) corpuscle size, especially average corpuscle size and/or corpuscle diameter; (ii) specific surface area, especially BET surface area; (iii) pore volume, especially adsorption volume and/or total pore volume; (iv) porosity and/or pore distribution, especially micropore volume contribution to total pore volume and/or average pore diameter; (v) impregnation and/or catalytic additization; and also (vi) corpuscle shape.

In this regard, it can be provided by way of example and in a nonlimiting manner that, in relation to the first particulate adsorption material (A), a spherical activated carbon of defined porosity is used, while an MOF material for example is used for the second particulate adsorption material (B). This is another way in which the spectrum of substances to be adsorbed can be increased and/or the adsorption properties can be adapted/custom-tailored to the substances to be absorbed, for example to their polarity and/or size.

The present invention is not restricted to the use of two particulate adsorption materials (A) and (B). On the contrary, still further particulate adsorption materials can be used according to the present invention, so that it can be provided according to the present invention for the adsorptive system according to the invention to have two or more, especially three, four, five or more mutually different particulate adsorption materials, in which case these adsorption materials are similarly subject to the definitions and properties recited in respect of the first particulate adsorption material (A) and/or in respect of the second particulate adsorption material (B).

To form a specifically mechanically stable adsorptive system according to the invention, it can be provided according to the present invention that the binder carrier forms at least one core of the respective adsorptive system. In addition the respective corpuscles and/or particles of the first particulate adsorption material (A) and of the second particulate adsorption material (B) of an individual adsorptive system and/or agglomerate can each be disposed and/or lodged at one or more than one core in the form of the binder carrier. In this case the individual agglomerates can each comprise one or more cores in the form of the binder carrier.

The size of the core formed of the binder can vary within wide limits. More particularly, the binder carrier and/or the core in the form of the binder carrier has a size of 100 to 2000 μm, especially 150 to 1500 μm and preferably 200 to 1000 μm. Usually, the size ratio of binder carrier and/or core in the form of the binder carrier to the individual adsorbent particle (A, B) is at least 1:1, especially at least 1.25:1, preferably at least 1.5:1, more preferably at least 2:1, even more preferably at least 3:1.

To ensure good adsorption efficiency, especially adsorption kinetics and adsorption capacity, the adsorptive system of the present invention may comprise at least 5 adsorbent particles (A) and/or (B), especially at least 10 adsorbent particles (A) and/or (B), preferably at least 15 adsorbent particles (A) and/or (B) and more preferably at least 20 adsorbent particles (A) and/or (B). In particular the adsorptive system (1) and/or the individual agglomerates can each comprise up to 50 adsorbent particles (A) and/or (B), especially up to 75 adsorbent particles (A) and/or (B) and preferably up to 100 adsorbent particles (A) and/or (B) or more. More particularly, the number of adsorbent particles increases as the corpuscle size of the particles decreases.

The weight ratio of adsorbent particles to organic polymer in the individual agglomerates can similarly vary within wide limits. In general, the adsorptive system according to the invention may include the first particulate adsorption material (A) and the second particulate adsorption material (B) in a weight ratio of first particulate adsorption material (A) to second particulate adsorption material (B) equal to at least 1:1, especially at least 1.2:1, preferably at least 1.5:1 and more preferably at least 2:1. The aforementioned weight ratios apply more particularly with the proviso that the first particulate adsorption material (A) has larger corpuscle diameters than the second particulate adsorption material (B).

It can further be provided according to the present invention that the adsorptive system according to the invention includes the first particulate adsorption material (A) and the second particulate adsorption material (B) in a corpuscle ratio of second particulate adsorption material (B) to first particulate adsorption material (B) equal to at least 1:1, especially at least 1.5:1, preferably at least 2:1 and more preferably at least 3:1. The aforementioned corpuscle ratios apply especially with the proviso that the first particulate adsorption material (A) has larger corpuscle diameters than the second particulate adsorption material (B).

The specific selection of the ratio of the respective particulate adsorption materials (A) and (B) relative to each other makes it possible for the adsorption properties to be further custom tailored/individually adjusted.

The weight ratio of adsorbent particles to binder carrier in the individual adsorptive systems can similarly vary within wide limits. In general, the adsorptive system includes a weight ratio of adsorbent particles (A) and (B) to binder carrier in the adsorptive system/agglomerate according to the invention of at least 2:1, especially at least 3:1, preferably at least 5:1, more preferably at least 7:1 and even more preferably at least 8:1. Usually, the adsorptive system of the present invention and/or the agglomerate will include a weight ratio of adsorbent particles (A) and (B) to a binder carrier per adsorptive system and/or agglomerate in the range from 2:1 to 30:1, especially 3:1 to 20:1, preferably 4:1 to 15:1 and more preferably 5:1 to 10:1. The aforementioned lower limits are motivated especially by the fact that a sufficient number/amount of adsorbent particles to ensure sufficient adsorption efficiency shall be present, whereas the aforementioned upper limits are more particularly motivated by the need to have a sufficient amount of binder carriers to ensure a stable ensemble/agglomerate.

In general, the individual agglomerates of the adsorptive systems of the present invention are self-supporting. This has the advantage that no additional support is needed.

As mentioned, the individual adsorptive systems according to the invention are generally in corpuscle form. The sizes of the corpuscles in the respective adsorptive systems according to the invention can vary within wide limits. More particularly, the adsorptive system according to the invention, or the agglomerate, can have a corpuscle size, especially an average corpuscle size, and a corpuscle diameter, especially an average corpuscle diameter D50, in the range from 0.01 to 20 mm, especially 0.05 to 15 mm, preferably 0.1 to 10 mm, more preferably 0.2 to 7.5 mm and even more preferably 0.5 to 5 mm.

The adsorptive system according to the invention further typically has a raspberry- or blackberrylike structure. In this structure, individual outer adsorbent particles or to be more precise the respective particulate adsorption materials (A) and (B) are disposed about one or more than one, preferably one, inner core, the core being formed by the binder. In this context, it is advantageous according to the present invention for the individual corpuscles/particles of the respective particulate adsorption materials to have been lightly pressed into the binder carrier, ensuring adequate fixation/adherence of the particulate structures on the binder carrier, on the one hand, and, on the other, adequate accessibility of the respective adsorbents to substances to be adsorbed, even in the fixed state of the corpuscles/particles. In this context, it is preferable according to the present invention for the outer surface of the corpuscles/particles of the corresponding particulate adsorption materials (A) and (B) to be covered by the binder carrier to at most 50%, especially to at most 40%, preferably to at most 30%, preferably to at most 20% and more preferably to at most 10%.

The binder forming the core of the adsorptive system according to the invention can be selected from a multiplicity of materials suitable for this. Advantageously, the binder is a thermoplastic material, in which case the binder should usually be further in heat-tacky form. Typically, the binder should be based on or consist of an organic polymer. In this context, the organic polymer should be thermoplastic. In addition, the organic polymer used for the binder should be in heat-tacky form. The organic polymer should further be selected from polymers from the group of polyesters, polyamides, polyethers, polyetheresters and/or polyurethanes and also their mixtures and copolymers. Adhesives based on copolyesters and/or copolyamides are also possible in particular.

The present invention is generally not restricted to the aforementioned polymers. On the contrary, inorganic-based materials, for example silica or the like, can also be used in relation to the binder. In addition, the use of argillaceous earth or pitch is also possible in respect of the binder—even though these embodiments are less preferable for the purposes of the present invention.

When, in accordance with the embodiment which is preferred according to the present invention, the binder is used on the basis of an organic polymer, the organic polymer should typically be a preferably thermoplastic binder, especially a preferably thermoplastic hot-melt adhesive. The thermoplastic binder should preferably be based on polymers from the group of polyesters, polyamides, polyethers, polyetheresters and polyurethanes and also their mixtures and copolymers.

Usually, the organic polymer, especially the binder, preferably the hot-melt adhesive, is solid at 25° C. and atmospheric pressure. This ensures outstanding adherence of particulate structures to the binder carrier at room temperature.

In addition, the organic polymer, especially the binder, preferably hot-melt adhesive, should, especially for technical and performance reasons, have a melting or softening range above 100° C., preferably above 110° C. and especially above 120° C. In general, the organic polymer, especially the binder, preferably the hot-melt adhesive, has a thermal stability temperature of at least 100° C., preferably at least 125° C. and especially at least 150° C.

To ensure good adsorption efficiency, especially adsorption kinetics and/or adsorption capacity, it is advantageous for the particulate adsorbent particles (A) and (B) of the adsorptive system according to the invention or of the agglomerate to be covered and/or coated with the binder carrier to at most 50%, especially to at most 40%, more preferably to at most 30% and even more preferably to at most 20% or less of their surface area, based on the total surface area of (A) and (B), respectively. This, as mentioned, ensures outstanding accessibility especially of the outer surface of particulate adsorption materials for substances to be adsorbed. A certain degree of coverage of the surface with the binder is required, however, to ensure good adherence of the particles/corpuscles of the respective particulate adsorbent particles (A) and (B) to the binder carrier.

In a particular embodiment of the present invention, the adsorptive systems according to the invention or to be more precise the agglomerates forming them can have been processed into a molded part, and this can be effected via pressing compression molding in particular.

It must also be regarded as a particular advantage of the adsorptive system of the present invention that the adsorptive system according to the invention and/or the corresponding agglomerate, especially in loose bedding or in the form of a molded part which each include a multiplicity of systems of the present invention, has a distinctly reduced pressure drop, especially compared with the respective adsorbent particles as such. This ensures that the medium to be cleaned, especially air, can efficiently flow through the adsorptive system. The adsorptive system and/or the agglomerate, especially in the form of a loose bed or of a molded part, has a length-based pressure drop at a flow velocity of 0.2 m/s of at most 200 Pa/cm, especially at most 150 Pa/cm, preferably at most 100 Pa/cm, more preferably at most 90 Pa/cm, even more preferably at most 70 Pa/cm and yet even more preferably at most 50 Pa/cm. Usually the adsorptive system and/or the agglomerate of the present invention, especially in the form of a loose bed or of a molded part, have a length-based pressure drop at a flow velocity of 0.2 m/s in the range from 5 to 200 Pa/cm, especially 5 to 150 Pa/cm, preferably 5 to 100 Pa/cm, more preferably 7.5 to 90 Pa/cm and even more preferably 10 to 80 Pa/cm.

By comparison, loose beddings of the same type of adsorbent particles as used in the adsorptive system of the present invention typically have length-based pressure drops at a flow velocity of 0.2 m/s in the range from 22 to 600 Pa/cm in the form of distinct corpuscles. As a result, the flow-through behavior of adsorptive systems according to the present invention is distinctly improved over the prior art.

In the realm of the present invention it is therefore possible, by proceeding from granular/spherical adsorbents/adsorbent particles and using a specific binder carrier, especially in the form of thermoplastic polymers, to produce adsorptive systems/agglomerates which are not only in the loose bed but also in a form compression molded/processed into an adsorptive molded part, have a very low pressure difference, especially compared for example with beddings of comparable granular/spherical adsorbents/adsorbent particles or splint carbon.

Moreover, the present invention is the first to succeed in achieving, in respect of an adsorptive system, a specific custom-tailoring and adjustment of adsorption properties, especially with regards to adsorption kinetics and adsorption capacity. It is accordingly possible in the realm of the present invention to, for example, provide within one and the same material in the form of the adsorptive system of the present invention, optimized adsorption properties for a large spectrum of substances to be adsorbed, for example in respect of substances differing in polarity, size or the like. In addition, adsorption capacity is distinctly increased owing to the optimized occupancy of the surface of the binder carrier.

The present invention is consequently associated with a multiplicity of advantages, of which only some were recited hereinabove and some more will now be enumerated in a non-limiting and non-closing manner:
As mentioned, the adsorptive system/agglomerate of the present invention has a distinctly reduced pressure difference in the loose bed compared with the mere base adsorbent particles, without other adsorption properties of the adsorption materials used, for example adsorption kinetics, adsorption capacity, initial breakthrough or the like, being significantly impaired, especially since these properties of the adsorption materials are at least substantially preserved in the adsorptive system of the present invention.
The multiplicity of possible combinations of adsorbent particles in the form of particulate adsorption materials, especially as defined above, results in respect of the adsorption properties in a multifunctionality and broad-bandedness, so that in effect adsorptive structures having distinctly improved adsorption properties are made available. The immense broad-bandedness or the multi-functionality is more particularly realized according to the present invention by the right-formed combination of two or more different types of adsorbent, wherein the adsorptive system of the present invention has a similar pressure drop to base agglomerates/systems having merely a single type of adsorbent corpuscle.
A further advantage of the concept of the present invention, which features the specific use of two or more different types of adsorbents and/or different particulate adsorption materials, is that not only the adsorption kinetics but also the adsorption capacity of the adsorptive system according to the invention are distinctly improved over base agglomerates based merely on one type of adsorbent—and this, as mentioned, at a similar pressure drop to the base agglomerates.
A further key advantage of the present invention is that the use of various particulate adsorption materials in relation to the adsorptive system of the present invention results in a significant increase in the surface area/volume ratio of the composite adsorbent according to the invention even compared with base agglomerates featuring only one type of adsorbent, i.e., that, according to the present invention, adsorption-capable surface areas are significantly increased by the optimized coating with the adsorbent particles in particular.
In addition, the adsorptive system/agglomerate of the present invention preserves the outstanding impregnatability of the base particles (more than 60% of the wetting test, for example).
There is further an improved/differentiated impregnation ability/endowment with catalytically active substances coupled with improved adsorption efficiency and adsorption kinetics for the present composite adsorbent based on the adsorptive system according to the invention even compared with base agglomerates featuring merely one adsorption material. More particularly, incompatible impregnations/catalysts can be established on the various types of adsorbent.
In addition, the adsorptive systems of the present invention are at least essentially dustless, which in particular is due to the very high mechanical stability of the adsorptive system according to the invention per se as well as due to the stability, especially the abrasion resistance and robustness, of the base particles which are used in the realm of the present invention in the form of particulate adsorption materials. More particularly, the adsorptive system of the present invention contains at least essentially no respirable dust particle sizes.
The free choice of respective agglomerate fractions and also the adjustment of the respectively employed particulate adsorption materials in the range from the base adsorbent particle diameters to the agglomerate diameters make the pressure drop freely adjustable.
As mentioned, a loose bedding of the adsorptive system/structure of the present invention is observed to suffer a distinctly lower pressure drop compared with granular or molded activated carbons for the same adsorption capacity.
The free choice and adjustability of respective particle size of the employed particulate adsorption materials (e.g., a differing surface area/volume ratio for the respective types of adsorbent) and the free choice/adjustability of the degree of activation of the base adsorbent particles (e.g., differing pore size distribution) in respect of the particulate adsorption materials used make the overall adsorption efficiency and overall adsorption kinetics adjustable/controllable, and a distinctly improved broad-spectrum efficacy is achieved on this basis.
It is further possible in the realm of the present invention for the bulk density and adsorption capacity at a predetermined pressure drop to be appropriately adjusted for example by free choice and coordination of the respective sizes of base adsorbent particles (e.g., different and/or mutually adjusted surface area/volume ratios for the respective types of adsorbent).
Owing to the high buffering volume, any adsorption loss due to the binder carrier, especially due to the organic polymeric constituents, is compensated, so that there is little if any pore volume blocked by the binder, especially by the organic polymeric constituents. Any loss of capacity due to the constituents of the binder carrier is extremely minimal.
It is additionally possible in the realm of the present invention, especially with regards to using the adsorptive system of the present invention in the form of a loose bed or a molded part, to vary/specifically custom tailor the pressure drop and/or the volume density, since these are each freely adjustable compared with the particulate base adsorbents as such.
A further advantage of the present invention is that the system/agglomerate of the present invention has good mechanical stabilities coupled with good flexibility and complexity, so that the adsorptive system according to the invention is readily compression moldable and can be processed, by using a multiplicity of adsorptive systems according to the invention, into corresponding stable and self-supporting adsorptive molded parts in any desired geometry, as will hereinbelow be described in detail.
The adsorptive system/agglomerate of the present invention provides in effect a very high degree of activation and thus a very high capacity to the base adsorbent particles, combined with a broadbandedness and multifunctionality of adsorption properties and with very good mechanical stability; agglomerate formation does not lead to any significant reduction in mechanical stability, compared with the non-agglomerated base adsorbent particles, and this while degrees of activation remain unchanged at a very high level.
The adsorptive system/agglomerate of the present invention, in addition to the above-described broad-bandedness/multifunctionality, also provides a high overall adsorption efficiency even at low adsorbate concentrations by virtue of very high possible adsorption potentials on the part of the base adsorbent particles. This overall adsorption efficiency can be improved still further through the concrete adjustment of the particulate adsorption materials used. More particularly, a high adsorption capacity, which is more particularly provided by the large adsorbent corpuscles, and a very good adsorption spontaneity, which is provided by the small adsorbent corpuscles, can be realized in one and the same material.
Because, finally, the surfaces of the particulate adsorption materials used are very clean, no significant drops in efficiency are observed as a result of high relative humidities and aging effects.

The present invention further provides—in accordance with a second aspect of the present invention—a process for producing adsorptive systems having a multiplicity of adsorbent particles, as defined above, wherein a first particulate adsorption material (A) and a second particulate adsorption material (B) are processed in the presence of a binder carrier, especially on the basis of at least one preferably thermoplastic organic polymer, into agglomerates each having a multiplicity of adsorbent particles of the first and second adsorption materials (A) and (B), wherein the adsorbent particles (A) and (B) are fixed, especially adhered, to the binder carrier and are each bound together by the binder carrier into agglomerates.

The process of the present invention can be carried out for example by proceeding from a mixture of the first particulate adsorption material (A) and of the second particulate adsorption material (B) and fixing/adhering said mixture on the binder carrier. This binder carrier should similarly be used in the form of corpuscles/particles. Advantageously, the corpuscle size/diameter, especially the average corpuscle size or the average corpuscle diameter D50, of the particle-shaped binder carrier should be selected to be larger than the corresponding values for the particulate adsorption materials (A) and (B) to be fixed, especially in order to fix an amount of adsorbent particles on the binder carrier that is sufficient to ensure a good adsorption capacity. The process of the present invention leads to particularly good results when the respective corpuscle sizes of the particulate adsorption filter materials (A) and (B) are within the same order of magnitude and more particularly have approximately equal values.

The process of the present invention can further be carried out by adding the respective particulate adsorption materials (A) and (B) in the form of the mixture or in separate lots/gradually to the binder carrier, in which case the resulting mixture can in each case be subsequently heated to temperatures above the melting/softening temperature of the binder carrier and the corresponding temperature can be maintained for a certain period. But it is also possible to maintain the temperatures during the entire period of addition or during the addition sequence of (A) and (B). In this context, the adsorbent particles (A) and (B) can be fixed on the binder carrier separately from each other or in succession. More particularly, the particulate adsorption materials (A) and (B) can be fixed on the heated and thus tacky/softened binder carrier by an energy inputment, for example by mixing, in which case the size of the resulting adsorptive systems according to the invention can be controlled by the magnitude of energy inputment for example.

The process of the present invention can be carried out for example in a heatable rotary tube or in a heatable rotary tube oven.

As part of the process according to the present invention, moreover, still further particulate adsorption materials can be applied to the particulate binder carrier by following the procedure described above. This results in an adsorptive system according to the invention which, in addition to the particulate adsorption materials (A) and (B), contains still further particulate adsorption materials (C), (D), (E), etc.

For further details concerning the present process according to the second aspect of the present invention, the above observations concerning the adsorptive system according to the invention and also the subsequent observations concerning the further aspects of the present invention can be referenced in that they apply mutatis mutandis in relation to the process according to the second aspect of the present invention.

The present invention further provides—in accordance with a third aspect of the present invention—a process for producing adsorptive systems, as defined above, having a multiplicity of adsorbent particles (A) and (B),
a) wherein initially a first particulate adsorption material (A) on the one hand and particles of a binder carrier, especially on the basis of at least one preferably thermoplastic organic polymer, on the other, are brought into contact and/or mixed,
b) wherein the resulting mixture is subsequently heated to temperatures above the melting or softening temperature of the binder carrier and the first particulate adsorption material (A) is made especially by energy inputment to adhere on the binder carrier and/or fixed to the binder carrier to obtain in this way intermediate products which include the first particulate adsorption material (A) and the binder carrier,
c) wherein where appropriate the resulting intermediate products are then cooled to temperatures below the melting or softening temperature of the binder of the binder carrier,
d) wherein then a second particulate adsorption material (B) is added to the intermediate products and/or brought into contact and/or mixed with the intermediate products,
e) wherein where appropriate the resulting mixture is subsequently heated again to temperatures above the melting or softening temperature of the binder of the binder carrier,
f) wherein the second particulate adsorption material (B) is made especially by energy inputment to adhere on the binder carrier and/or fixed to the binder carrier to obtain in this way products which include the first particulate adsorption material (A), the second particulate adsorption material (B) and the binder carrier, and
g) wherein finally the resulting products are cooled down to temperatures below the melting or softening temperature of the binder of the binder carrier to obtain discrete adsorptive systems.

Typically, the attained temperature is maintained for a defined period in step a) and/or step e) and/or step f) independently of each other, especially for at least one minute, preferably at least 5 minutes, preferably at least 10 minutes, and/or for a period of 1 to 600 minutes, especially 5 to 300 minutes and preferably 10 to 150 minutes. The length of time for which the temperature is maintained is more particularly determined according to the requirement that the entire lot is in each case brought to a unitary temperature to improve the adherence of the particulate adsorbents on the binder carrier. In addition, the length of time for which the temperature is maintained according to the present invention ensures that the binder carrier is melted at least essentially completely in order thereby to enable good adherence of the particulate structure on the binder carrier. The temperature can similarly be maintained throughout the entire sequence of fixing the particles (A) and (B), i.e., set above the melting/softening temperature of the binder.

The particulate adsorption material (A) used in step a) should be selected such that, in the course of fixing the corresponding particles/corpuscles on the binder carrier in step b), a corresponding part of the surface area of the binder carrier does not become occupied by the first particulate adsorption material (A) or free surface regions remain on the binder carrier for subsequent fixation/attachment of the second particulate adsorption material (B). This can be controlled for example by selecting the type, such as corpuscle size/diameter, and/or amount of the first particulate adsorption material (B). In general, moreover, the corpuscle size/diameter, especially the average corpuscle size and the average corpuscle diameter D50, of the binder used should be larger than the corresponding values of the employed particulate adsorption materials (A) and (B), respectively.

During the performance of step b) and/or step d) and/or step e), especially in the course of the heating and maintaining operation, it is particularly advantageous when, independently of each other, an energy inputment is effected, preferably via mixing. The energy inputment in this regard can be used to control the resulting agglomerate size and/or size of the resulting adsorptive systems according to the invention. The amount and type of energy inputment, therefore, can be used to control the corpuscle size and/or corpuscle diameter, especially the average corpuscle size and/or the average corpuscle diameter D50, or the resulting agglomerates—and this not only with regard to step b) and/or d) and/or step e) of the process of the present invention.

The second particulate adsorption material (B) added in step f) also advantageously, for the purposes of the present invention, has a smaller particle size or a smaller corpuscle size and/or a smaller corpuscle diameter, especially a smaller average corpuscle size and/or a smaller average corpuscle diameter D50, than the first particulate adsorption material (A) in order thereby to make it possible in particular for the free/unoccupied regions of the binder carrier of the agglomerates/intermediate products obtained in step b) to subsequently be occupied with the second particulate adsorption material (B).

Typically, the process of the present invention is performed in a heatable rotary tube, especially a rotary tube oven. The rotary speed of the rotary tube can be used to control the energy inputment and thus especially the resulting agglomerate size and/or size of the adsorptive systems according to the invention. Increasingly smaller agglomerate sizes are obtainable with increasing energy inputment. Correspondingly, increasingly smaller agglomerate sizes are obtainable with increasing rotary speed. Batchwise emptying of the rotary tube, moreover, makes it possible to obtain altogether multimodal agglomerate size distributions especially by varying the rotary speeds for the individual batches.

In one particular embodiment of the present invention, the adsorptive systems resulting in step g) can be processed in a subsequent step h) into a molded part, especially by compression molding. The processing into molded parts can be effected by heating, preferably to temperatures below the melting or softening temperature of the binder carrier, so that the agglomerates concerned are not decomposed and/or do not disintegrate.

As mentioned, the adsorbent particles (A) and (B) should be selected such that the first particulate adsorption material (A) and the second particulate adsorption material (B) have at least one mutually different physical and/or chemical property, especially at least one mutually different physical and/or chemical parameter, preferably mutually different average corpuscle sizes and/or average corpuscle diameters D50.

In the realm of the production process of the present invention for the adsorptive systems/agglomerates of the present invention, the binder carrier, especially in the form of a thermoplastic organic polymer, is used in the form of particles, especially granular or spherical particles, preferably in the form of particles that are solid at room temperature and atmospheric pressure. The term “room temperature” relates especially to 25° C., while the term “atmospheric pressure” relates especially to 1013 hPa. In general, the binder carrier can be used with particle sizes in the range from 100 to 2000 μm, especially 150 to 1500 μm and preferably 200 to 1000 μm. Usually, the size ratio of particulate binder carrier to adsorbent particles (A) and/or (B) can be chosen to be at least 1:1, especially at least 1.25:1, preferably at least 1.5:1, more preferably at least 2:1 and even more preferably at least 3:1. The respective quantitative ratios between the particulate binder carrier relative to the particulate adsorption material (A) on the one hand and relative to the second particulate adsorption material (B) can be chosen independently of each other.

It can similarly be provided in the realm of the production process of the present invention that the weight ratio of adsorbent particles (A) and/or (B) to binder carrier is chosen to be at least 2:1, especially at least 3:1, preferably at least 5:1, more preferably at least 7:1 and even more preferably at least 8:1. Usually, the weight ratio of adsorbent particles (A) and/or (B) to organic polymer is chosen in the range from 2:1 to 30:1, especially 3:1 to 20:1, preferably 4:1 to 15:1 and more preferably 5:1 to 10:1.

As mentioned, the binder carrier used is especially an organic polymer, preferably a thermoplastic organic polymer, especially a preferably thermoplastic hot-melt adhesive, preferably based on polymers from the group of polyesters, polyamides, polyethers, polyetheresters and/or polyurethanes and also their mixtures and copolymers. Useful binder carriers further include polyolefins and also specifically thermoplastically modified cellulose derivatives, especially caramelized sugars, sugar derivatives and/or specifically thermoplastically modified starch.

For further details concerning the present process according to the third aspect of the present invention, the above observations and also the subsequent observations concerning the further aspects of the present invention can be referenced in that they apply mutatis mutandis in relation to the production process according to the present invention according to this aspect of the present invention.

A typical embodiment can be carried out as follows for example: Hot-melt adhesives can be used as binder carriers, in which case it is typically possible to use a multiplicity of suitable hot-melt adhesives. More particularly, hot-melt adhesives can be used in the form of thermoplastic copolyamides and/or thermoplastic copolymers in pellet and/or powder form. For example, hot-melt adhesives in the form of copolyesters can be used as binder carriers. Hot-melt adhesives of this type are available for example from EMS-Chemie GmbH & Co. KG, Neumünster.

More particularly, the hot-melt adhesives can be used in corpuscle form. In this case, the corpuscle size of the hot-melt adhesive should advantageously be greater than the corpuscle size of the employed particulate adsorption materials (A) and (B) in order thereby to prevent more particularly a downward descent of adhesive constituents/particles in the bed. In general, the employed binder carriers, especially in the form of hot-melt adhesives, can have adjustable thermal and/or chemical properties, so that this can be used to achieve optimized adherence of the respectively employed particulate adsorption materials (A) and/or (B).

As mentioned, the particulate adsorption materials (A) and/or (B) can be produced/used in the form of spherical base particles on the basis of polymeric raw materials for example. The particulate adsorption materials (A) and (B) used according to the present invention are notable for a multiplicity of advantages, of which a high adsorption capacity, a high degree of chemical purity and also extremely good mechanical properties must be emphasized in this regard.

More particularly, the shaping of the particulate adsorption materials (A) and (B), or of the base particles, is spherical independently of each other, in which case the particulate adsorption materials (A) and (B) can be used more particularly in a particle size of d_{(particle)} of 0.05 to 0.7 mm, in which case the second particulate adsorption material (B) has smaller values in particular. Values departing therefrom are also possible. More particularly, monodisperse particle size distributions can be used in respect of particle sizes or corpuscle diameters or corpuscle sizes for (A) and (B) independently of each other as well as polydisperse particle size distributions in general. This more particularly also applies to the corpuscle sizes/diameters recited for the first particulate adsorption material (A) and, respectively, the second particulate adsorption material (B) in accordance with the first aspect of the present invention. In this regard, it can also be possible in the realm of the present invention for the size distributions in respect of the first particulate adsorption material (A) and the second particulate adsorption material (B) to occasionally minimally overlap/coincide with regard to their corresponding edge regions, i.e., the particles of the material with the smaller corpuscle sizes, especially of the second particulate adsorption material (B), that are largest in the particle size distribution can come within the smallest particle size range of the material with the larger corpuscle sizes with regard to the particle size distribution, especially of the first particulate adsorption material (A), and vice versa.

With regard to the usable particulate adsorption materials (A) and (B), it is possible to achieve, on the basis of the specifically selected raw material and specific production processes, pore volumes close to the theoretical feasibility, for example in that surface areas of up to 2300 m²/g or more as per ASTM D6554-04 and also total pore volumes of up to 3.5 cm³/g or more can be produced.

Steps a) and b) of the process according to the present invention are in effect concerned with producing the base agglomerates, i.e., they result in a first adsorptive system based on the binder carrier and on the first particulate adsorption material (A), as indicated above. It is thus the case that these steps of the process according to the present invention convert spherical base particles in the form of the first particulate adsorption material (A) and binder carriers, especially in the form of hot-melt adhesives, especially by thermal and mechanical treatment of the corresponding base agglomerates/intermediate products. The base agglomerates thus produced, as mentioned, can be coated, in further subsequent steps, with the second particulate adsorption material (B) and optionally with further materials.

To produce the adsorptive systems/agglomerates of the present invention, or the composite adsorbents of the present invention, the particle size distribution of the spherical base particles in the form of the first particulate adsorption material (A) should be chosen such that, as mentioned, free adhesive areas are produced or are present on the binder carrier which are accessible to the second particulate adsorption material (B) and which, in subsequent steps, can be coated with the second particulate adsorption material (B) and/or the optionally further adsorption materials. More particularly, the particle size or the corpuscle size and/or the corpuscle diameter of the base particles or of the first particulate adsorption material (A) can be changed/adjusted depending on the particle size or corpuscle size or corpuscle diameter of the second particulate adsorption material (B). As coating proceeds, the respective corpuscle sizes of the corresponding materials should further decrease.

The thermal treatment of the bedding depends in particular on the binder carrier or type of adhesive used, as mentioned. The target temperature should be greater/within the melting temperature of the binder carrier used, especially with the proviso that the result is a tacky surface to adhere/fix the particulate materials. The target temperature chosen should be the minimum possible, since any further temperature increase and thus any further reduction in the viscosity of the adhesive/binder carrier once the melting/softening temperature has already been attained for the binder carrier/adhesive present would lead to an increased and thus undesired degree of pore blocking in the adsorbent particles and the adsorbent particles might penetrate too deeply into the binder matrix. Care must further be taken to ensure that, in the realm of the process of the present invention, the respective beddings (e.g., binder carrier/adsorption material (A) on the one hand and intermediate product or base agglomerate/adsorption material (B) on the other) should be heated to the target temperature, so that appropriate maintaining times should be used in respect of the established temperature in order that complete and homogeneous heating of the entire bedding may be ensured.

As far as the mechanical treatment or the energy inputment especially in process steps b) and/or f) is concerned, the energy inputment in question should be effected by rotation of a rotary tube reactor/oven used to produce the adsorptive systems of the present invention. This also ensures adequate commixing of the bedding and also an adequate input of heat into the bedding. Furthermore, the mixed state of the components can also be effected in step a) and/or d) by energy inputment, especially mixing. In relation to process step b), the bedding preferably comprises the first particulate adsorption material (A) and also the binder carrier, while the intermediate product with the second adsorption material (B) is present in step f). An adequate contact between the binder carrier/adhesive on the one side and the first particulate adsorption material (A) is produced in relation to step b), wherein more particularly at least essentially all free adhesive areas on the binder carrier which are accessible to the corresponding particle size distribution of the first particulate adsorption material (A) become gradually coated in particular, i.e., as the rotary tube oven continues to rotate, the binder carrier becomes increasingly coated with the base particles or with the first particulate adsorption material (A). As mentioned, elevated rotary speed of the rotary tube oven can be used to influence the agglomerate size distribution in a targeted/defined manner in that, more particularly, an elevated rotary speed on the part of the rotary tube oven/reactor leads to smaller sizes on the part of the agglomerates. The same holds mutatis mutandis for fixing adsorption material (B).

As mentioned, subsequent steps of the process according to the present invention use a second particulate adsorption material (B) and/or further materials to convert the base agglomerates already produced into the adsorptive system/agglomerate of the present invention or the composite adsorbent of the present invention, for which the process of the present invention can be more particularly carried out as a batch operation, or batchwise.

As mentioned, the particle size distribution or the corpuscle size/diameter of the second particulate adsorption material (B) should be chosen such that the free and coatable areas on the binder carrier, or the adhesive areas there, can be reached/coated by the second particulate adsorption material (B). Against this background in particular, the second particulate adsorption material (B) should be present/used in smaller corpuscle sizes/diameters, as mentioned, compared with the first particulate adsorption material (A). More particularly, the particle size of the spherical base particles or of the first particulate adsorption material (A) can be changed/adjusted as a function of the second particulate adsorption material (B), and vice versa.

As mentioned, the first particulate adsorption material (A) and/or the second particulate adsorption material (B) can each utilize, independently of each other, a multiplicity of materials, for example spherical adsorbents including—especially with regard to the second particulate adsorption material (B)—in the form of mini-beads and also in the form of adsorbents of fine and very fine grain size; activated carbons, such as granular activated carbon, for example from coconut shells, molded and/or extruded activated carbon, pulverulent activated carbon; zeolites, such as natural zeolites and/or synthetic zeolites; molecular sieves, such as zeolitic molecular sieves, synthetic molecular sieves based on carbon, oxides or glasses; metal oxides or metals, for example nanoparticles in relation to the second particulate adsorption material (B); ion exchanger resins, for example cation and/or anion exchangers which can be selected to be polydisperse and/or monodisperse, of the gel type and/or of the macroporous type; so-called MOFs, COFs, ZIFs, POMs, OFCs and/or porous polymers; crown ethers and cryptands.

In the realm of the present invention, it is more particularly possible to exercise sensible selection and to apply further components in addition to the particulate adsorption materials (A) and (B). The guiding principle here should be, as mentioned, that the particle size distribution of the respective materials should decrease in particular with every further step, especially because free areas on the surface of the binder carrier have to become accessible again and again.

The optionally performed renewed thermal treatment and/or the continuing thermal treatment to fix the second particulate adsorption material (B) should similarly depend on the binder carrier, or type of adhesive, used. More particularly, the entire process does not utilize any further adhesive to produce the adsorptive systems or composite adsorbents of the present invention.

As mentioned, the target temperature to fix the second adsorption material (B) should also be greater/within the melting temperature range of the adhesive. The adhesive already present in the base agglomerates involving the first particulate adsorption material (A) is again or remains incipiently melted, so that the second particulate adsorption material (B) can become fixed in the tacky free adhesive areas on the binder carrier. What must be especially borne in mind in this regard is that, especially in the realm of process step d) and/or e) and/or f) of the process of the present invention, a bedding of base agglomerates containing the first particulate adsorption material (A) and the binder carrier should be heated to a defined target temperature. Appropriate maintaining times can be used especially in this regard in order that complete heating of the entire bedding of base agglomerates and the second particulate adsorption material (B) may be achieved.

As mentioned, process step f) comprises a second mechanical treatment or a further energy inputment, which can in either case be similarly ensured by the rotation of the rotary tube oven/reactor used in order that adequate commixing of the bedding and also adequate inputment of heat into the bedding may be achieved. This bedding, as mentioned, comprises base agglomerates based on the first particulate adsorption material (A) and the binder carrier and the added second adsorption material (B). The rotation of the rotary tube oven ensures adequate contact between the base agglomerates on the one side and the second particulate adsorption material (B), or the optionally further materials, on the other, and more particularly the free adhesive areas on the binder carrier which are accessible to the corresponding particle size distribution of the second particulate adsorption material (B) become gradually coated, so that this provides the adsorptive systems of the present invention, comprising the first particulate adsorption material (A) and the second particulate adsorption material (B).

As mentioned, step g) of the process according to the present invention finally comprises cooling down the resulting agglomerates according to the invention.

The present invention further provides—in accordance with a fourth aspect of the present invention—a further production process to obtain the adsorptive structure/systems of the present invention.

The present invention accordingly also provides a process for producing adsorptive systems, as defined above, having a multiplicity of adsorbent particles (A) and (B),
a) wherein initially a first particulate adsorption material (A) and a second particulate adsorption material (B) on the one hand and an especially particulate binder carrier, especially on the basis of at least one preferably thermoplastic organic polymer, on the other are brought into contact and/or mixed,
b) wherein the resulting mixture is subsequently heated to temperatures above the melting or softening temperature of the binder carrier and the first particulate adsorption material (A) and the second particulate adsorption material (B) are made especially by energy inputment to adhere on the binder carrier and/or fixed to the binder carrier, and
c) wherein finally the resulting products are cooled down to temperatures below the melting or softening temperature of the binder of binder carrier to obtain discrete adsorptive systems.

This production process of the present invention to obtain the adsorptive systems according to the invention thus proceeds from a mixture of the first particulate adsorption material (A) and of the second particulate adsorption material (B) and they can subsequently be applied to the particulate binder carrier simultaneously as it were.

In other respects concerning the process of the present invention in accordance with this aspect of the present invention, reference can be made to the further details concerning the other aspects of the present invention which apply mutatis mutandis in respect of the process of the present invention in accordance with the fourth aspect of the present invention.

The adsorptive systems of the present invention are accordingly obtainable on the basis of the processes described above.

The present invention further provides—in accordance with a fifth aspect of the present invention—the uses of the adsorptive systems of the present invention.

The adsorptive systems of the present invention, as defined above, having a multiplicity of adsorbent particles (A) and (B) can be used for the adsorption of toxics, noxiants and odors, especially from gas or air streams or alternatively from liquids, especially water.

In addition, the adsorptive systems of the present invention, as defined above, having a multiplicity of adsorbent particles (A) and (B) can be used for cleaning or purifying gases, gas streams or gas mixtures, especially air, or liquids, especially water.

In addition, the adsorptive systems of the present invention, as defined above, having a multiplicity of adsorbent particles (A) and (B) can be used in adsorption filters and/or for production of filters, especially adsorption filters.

The adsorptive systems of the present invention, as defined above, having a multiplicity of adsorbent particles (A) and (B) can further be used as a sorption store for gases, especially hydrogen.

In addition, the adsorptive systems of the present invention, as defined above, having a multiplicity of adsorbent particles (A) and (B) can be used—in accordance with a sixth aspect of the present invention—for production of adsorptive molded parts, especially by compression molding.

In relation to the aforementioned uses, the adsorptive systems according to the invention can be used in loose bedding especially. Alternatively, the adsorptive systems can also be used in the form of a molded part produced therefrom via compression molding in particular. Typical beddings and/or molded parts can generally have a height of 1 to 10 cm, especially of 2 cm, and/or a diameter of 1 to 15 cm, especially 5 cm.

The present invention yet further provides—in accordance with a seventh aspect of the present invention—a filter which contains the adsorptive systems according to the invention, as defined above, having a multiplicity of adsorbent particles, preferably in loose bedding, wherein the filter has a length-based pressure drop at a flow velocity of 0.2 m/s of at most 200 Pa/cm and especially in the range from 5 to 200 Pa/cm. In this context, the filter should have a length-based pressure drop at a flow velocity of 0.2 m/s of at most 150 Pa/cm, preferably at most 100 Pa/cm, more preferably at most 90 Pa/cm, even more preferably at most 70 Pa/cm and yet even more preferably at most 50 Pa/cm. Typically, the filter according to the invention should have a length-based pressure drop at a flow velocity of 0.2 m/s in the range from 5 to 150 Pa/cm, preferably 5 to 100 Pa/cm, more preferably 7.5 to 90 Pa/cm and even more preferably 10 to 80 Pa/cm.

For further details concerning the filter of the present invention, reference can be made to the above observations concerning the other aspects of the present invention and to the observations hereinbelow which apply mutatis mutandis in respect of this aspect of the present invention.

The present invention yet further provides—in accordance with an eighth aspect of the present invention—an adsorptive molded part constructed of a multiplicity of adsorptive systems, as defined above.

A still further aspect of the present invention—in accordance with a ninth aspect of the present invention—is a process for producing the adsorptive molded part, as defined above, wherein adsorptive systems according to the invention, as defined above, are conjoined, especially compression molded.

The present invention finally further provides—in accordance with a tenth aspect of the present invention—a filter which contains the abovementioned adsorptive molded part according to the invention.

In addition to the aforementioned particulate adsorption materials, the adsorptive system of the present invention may in general additionally include fibrous structures or fibers as such, in which case the corresponding fibers can similarly be fixed on the surface of the binder carrier in particular. The additional incorporation of fibers into the adsorptive system of the present invention can be used to provide an additional particle/aerosol filter capability. In addition, the fibers can act as spacers to space apart the systems of the present invention in a loose bedding for example in order thereby to improve the flow-through behavior, especially in association with a reduced pressure drop. In this context, fiber types known per se to a person skilled in the art can be used, for example natural fibers and/or synthetic fibers. In this regard, the fibers can have for example fiber lengths of 0.1 to 100 mm and/or fiber diameters of 100 nm to 1 mm.

Further advantageous properties, aspects and features of the present invention will become apparent from the following description of exemplary embodiments illustrated in the figures, of which:

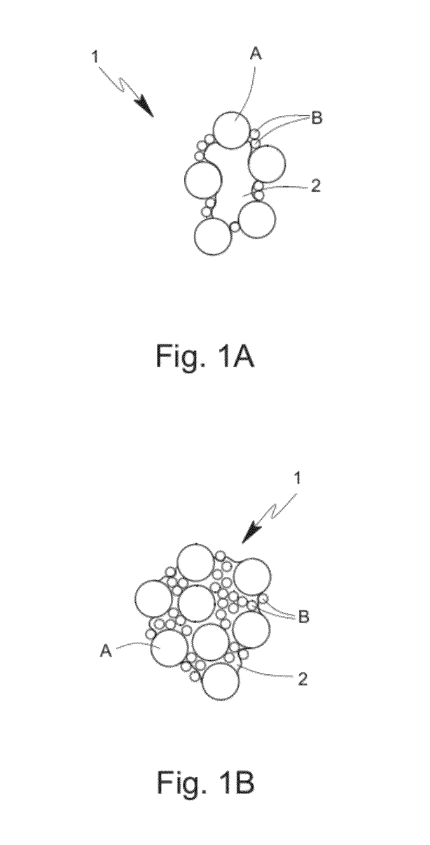

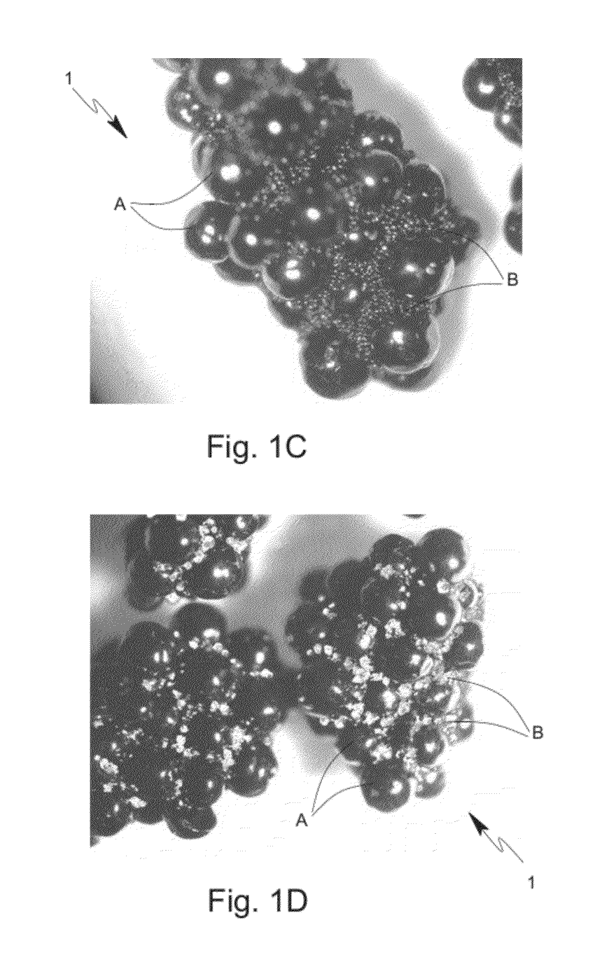

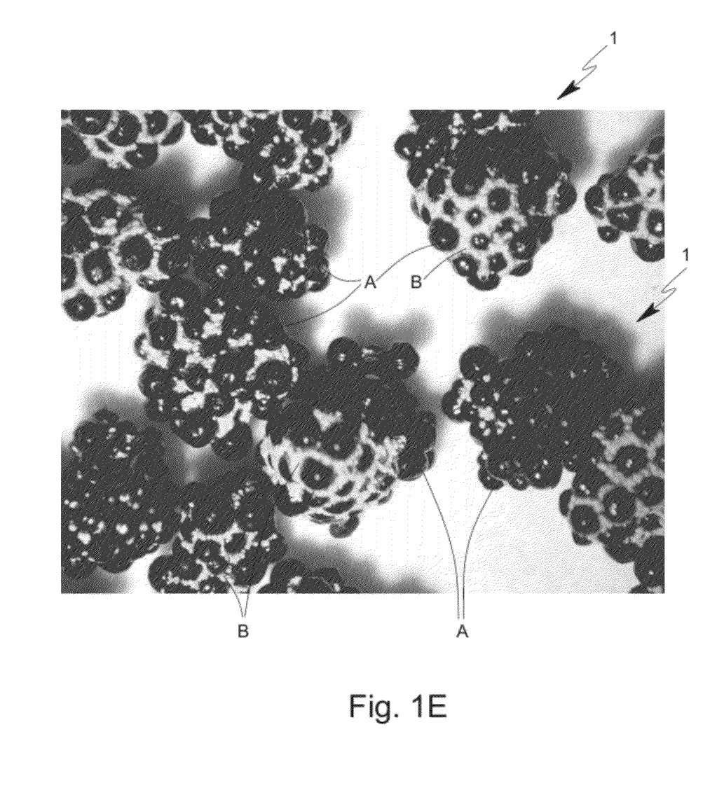

FIG. 1A shows a schematic cross-sectional depiction of an inventive adsorptive system with adsorbents fixed to a binder carrier which are in the form of a first particulate adsorption material (A) and a second particulate adsorption material (B);

FIG. 1B shows a schematic plan view of an inventive adsorptive system with adsorbents applied atop a binder carrier which are in the form of a first particulate adsorption material (A) and a second particulate adsorption material (B);

FIG. 1C shows a magnified photographic depiction of an inventive adsorptive system with fixed adsorbents in the form of a first particulate adsorption material (A) and a second particulate adsorption material (B);

FIG. 1D shows a magnified photographic depiction of a further adsorptive system according to the invention with an applied first particulate adsorption material (A) and a second particulate adsorption material (B);

FIG. 1E shows a magnified photographic depiction of a multiplicity of inventive adsorptive systems, wherein the individual adsorptive systems according to the invention each include a first particulate adsorption material (A) and also a second particulate adsorption material (B);

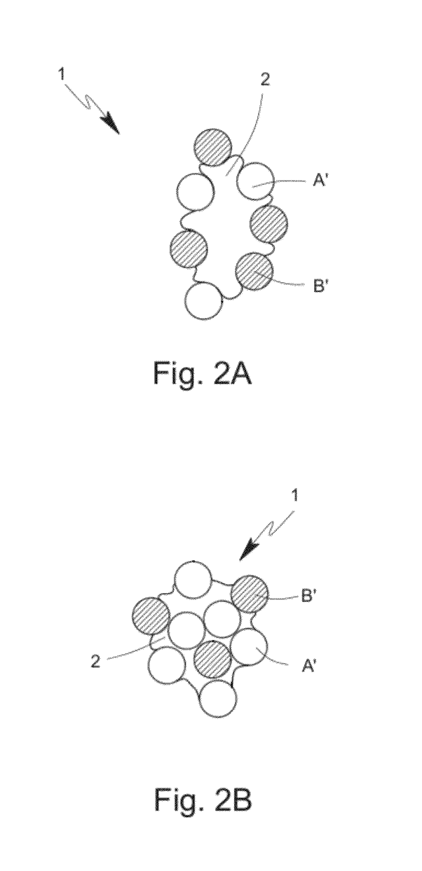

FIG. 2A shows a schematic cross-sectional depiction of the inventive adsorptive system in a further embodiment of the present invention wherein the adsorptive system includes a first particulate adsorption material (A′) and a second particulate adsorption material (B′) which are each secured to a binder carrier;

FIG. 2B shows a schematic plan view of an inventive adsorptive system in a further embodiment of the present invention with a first particulate adsorption material (A′) and a second particulate adsorption material (B′);

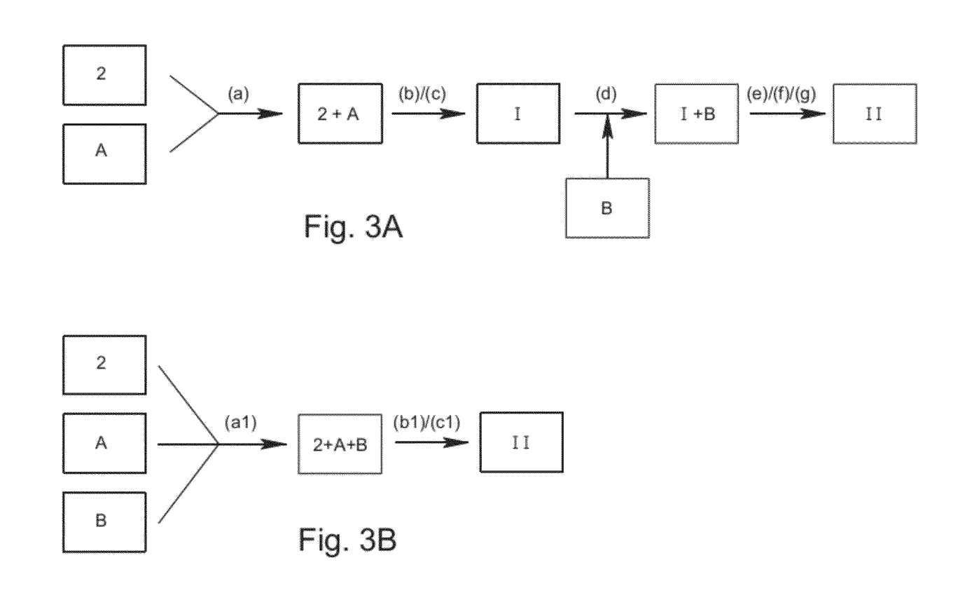

FIG. 3A shows a schematic depiction of the inventive process in a first embodiment of the present invention for producing the adsorptive systems of the present invention;

FIG. 3B shows a schematic depiction of the inventive process for producing the adsorptive systems according to the invention in a further embodiment.

FIGS. 1A to 1E relate to the embodiment which is preferred according to the invention, whereby the employed particulate adsorption materials (A) and (B) have corpuscle sizes that differ from each other at least. FIG. 2A and FIG. 2B relate to the embodiment of the present invention whereby the particulate adsorption materials used have at least essentially identical corpuscle sizes/diameters and the particulate adsorption materials used differ from each other in at least one physical and/or chemical parameter, as defined above.

FIG. 3A schematicizes the workflow of the inventive process for producing the adsorptive structure (1) according to the invention in a first embodiment, whereby initially, in accordance with step c), a first particulate adsorption material (A) on one side and a binder carrier 2 are contacted/mixed with each other. In this respect, the particulate adsorption material (A) can be used as base adsorbent with defined properties. The binder carrier 2 should be conformed in respect of its particle size to the particle size of the employed particulate adsorption material (A)/base adsorbent, especially as defined above. The step of contacting the components is accompanied and/or followed by the resulting mixture being heated to temperatures above the melting/softening temperature of the binder carrier as per step b), wherein the thermal treatment should be carried out as a function of the relevant properties of the binder carrier/adhesive used. The inputment of energy in the form of a mechanical treatment establishes contact between the binder carrier on the one hand and the first particulate adsorption material (A) on the other, and the adsorptive particles become fixed/adhered on the binder carrier 2. This can be followed, in accordance with step c), by a step of cooling the resulting intermediate products in the form of agglomerates with the first particulate adsorption material (A) to obtain the intermediates/agglomerates (I). In a further step, the agglomerates I are admixed with the second particulate adsorption material (B) in step d). This is optionally followed, in accordance with step e), by renewed heating; while the temperature can also be maintained. A further thermal treatment thus takes place, which is again performed as a function of the binder carrier/adhesive used. Step f) then comprises a further energy inputment in the form of a mechanical treatment to establish contact between the second particulate adsorption material (B) and the first agglomerates I and cause the second particulate adsorption system (B) to become fixed/adhered on the free areas of binder carrier 2. This is followed, in step g), by cooling to obtain the inventive adsorptive systems 1 in the form of composite adsorbents (adsorbent agglomerates II).

In an alternative embodiment of the present invention, in accordance with the scheme of FIG. 3B, the inventive adsorptive systems 1 can be produced by the inventive process wherein, in a first step a1), not only the first particulate adsorption material (A) but also the second particulate adsorption material (B) on the one hand and the binder carrier 2 on the other can be mutually contacted and mixed in particulate form. Thereafter or during mixing, a thermal treatment is carried out according to step b1) to adhere the particulate adsorption materials (A) and (B) on the corpuscles of binder carrier 2 by energy inputment in particular. This is followed in step c1) by cooling to obtain the inventive adsorptive systems in the form of composite agglomerates II.

Further elaborations, modifications and variations of the present invention will become mutually apparent to and realizable by the ordinarily skilled in the art on reading the description without their having to go outside the realm of the present invention.

The present invention is illustrated by the following exemplary embodiments which, however, shall in no way limit the present invention.

### EXEMPLARY EMBODIMENTS

The production of adsorptive systems according to the invention on the basis of agglomerates by using a first particulate adsorption material (A) and a second particulate adsorption material (B) and also the production of comparative systems will now be described.

### 1. Inventive Agglomerates (A1)

The production of inventive adsorptive systems or agglomerates A1 proceeds by initially providing base particles or the first particulate adsorption material (A) in the form of activated carbon. The first particulate adsorption material in the form of activated carbon is based on a polymeric raw material, which is subjected to a carbonization. The first particulate adsorption material (A) has a total pore volume V₍ₜₒₜ₎ of 0.63 cm³/g and also a specific surface area A_{(BET)} of 1350 m²/g. The first particulate adsorption material (A) further has a polydisperse particle size distribution with d_{(particle)}=0.45 to 0.71 mm. Such a particulate adsorption material (A) in the form of activated carbon is obtainable for example from Blücher GmbH, Erkrath, Germany, or from Adsor-Tech GmbH, Premnitz, Germany.

As far as the binder carrier is concerned, thermoplastic hot-melt adhesive particles having grain sizes ranging from 200 to 1000 μm are used in a weight-based adhesive use ratio (binder carrier/base particle ratio) of 1:7. The hot-melt adhesive can be for example of the 9EP type, available from EMS-Chemie AG, EMS-GRILLTECH, Switzerland.

The particulate adsorption material (A) on the one hand and the binder carriers on the other are mutually contacted and mixed in a rotary tube while heating is effected to a target temperature of T=175° C. at a gradient of dT/dt=2° C./min to reach the target temperature. The maintaining time after reaching the target temperature is t=30 min. The rotary speed of the rotary tube reactor is n=5 rpm. This is followed by agglomerate sieving to d_{(agglomerate)} from 1.25 to 2.5 mm.

In a further step, the inventive adsorptive systems/composite adsorbents are obtained from the previously obtained base agglomerates by renewed heating and adding the second particulate adsorption material (B). The second particulate adsorption material (B) is based on a particulate MOF material (Cu₃(BTC)₂). The second particulate adsorption material (B) has a total volume V₍ₜₒₜ₎ of 0.58 cm³/g and a specific surface area A_{(BET)} of 1427 m²/g. The particle size distribution of the second particulate adsorption material is polydisperse at d_{(particle)}<0.071 mm.

The second particulate adsorption material (B) is contacted and mixed with the base agglomerates, while the mixture is heated to a target temperature of T=175° C. and a gradient of dT/dt=2° C./min to reach the target temperature. The maintaining times after reaching the target temperature is t=30 min. After cooling, the composite adsorbents are sieved off to d_{(composite adsorbent)} from 1.25 to 2.5 mm. This accordingly results in inventive adsorptive systems A1 based on a first particulate adsorption material (A) in the form of activated carbon on the one hand and a second particulate adsorption material (B) in the form of an MOF material, wherein the second particulate adsorption material (B) has smaller particle sizes than the first particulate adsorption material (A) has.

### 2. Inventive Agglomerates (A2)

The second inventive adsorptive systems/composite agglomerates A2 are produced as described above at 1.), again using a first particulate adsorption material (A) in the form of activated carbon as described under 1.). The second particulate adsorption material (B) is a spherical activated carbon, which is obtained from a polymeric raw material, in the form of small spherules or so-called minibeads having a total pore volume V₍ₜₒₜ₎ of 0.97 cm³/g and a specific surface area A_{(BET)} of 1613 m²/g. The second particulate adsorption material (B) has a polydisperse particle size distribution at d_{(particle)}<0.15 mm. This accordingly results in inventive adsorptive systems/composite agglomerates A2, which contain particulate adsorption materials (A) and (B) in the form of activated carbon having mutually different corpuscle sizes, total pore volumes and BET surface areas.

### 3. Adsorptive Agglomerates (B1) (Comparator)

Agglomerates B1 are produced as comparator/non-inventive example in that they merely include a unitary particulate adsorption material. The procedure adopted in this regard is that, to obtain the noninventive agglomerates (B1), a particulate adsorption material (A) is applied to a binder carrier, where the particulate adsorption material (A) and also the binder carrier correspond to the materials previously defined in the inventive examples. Noninventive agglomerates (B1) are obtained after the adsorbent particles have become fixed on the binder carrier.

### 4. Adsorption Particles (B2) (Comparator):

A further comparative example is a particulate adsorption material as such, which is present in the form of a loose bedding of respective adsorbent particles. The adsorbents B2 are about 0.3 to about 0.6 mm in size.

5. Investigations into Pressure Drop and Breakthrough Behavior of Compositions
a) In a first experimental section, pressure drop is determined for the inventive combiadsorbent A1 and also for a further inventive combiadsorbent A1a, for which the agglomerates are used in the form of loose beds. The combiadsorbent A1a according to the invention corresponds to inventive combiadsorbent A1 with the proviso that corpuscle sizes for the agglomerates are in the d_{(particle)} range from 0.8 to 1.25 mm in relation to the combiadsorbent A1a.
   Pressure drop measurement leads to the values reported below in table 1:

The table hereinbelow shows the results on the basis of breakthrough curves.

TABLE 1
Pressure drop measurements on various
adsorptive structures

| | | Sample | | |
|---|---|---|---|---|
| | | Agglomerate | Agglomerate | |
| | | (A1) | (A1a) | Adsorber (B2) |
| Size | | 1.25 to 2.5 mm | 0.8 to 1.25 mm | 0.3 to 0.6 mm |
| d_{(particle)} | | | | |
| Pressure | Pa/cm at | 11 | 23 | 131 |
| drop | 0.1 m/s | | | |

The results above show that pressure drop is highest for the noninventive adsorbents B2 in the form of a loose bedding, while lower pressure drops are observed for the inventive combiadsorbents A1 and A1a in that the pressure drop further decreases with increasing agglomerate size.
b) A second experiment is carried out to determine the breakthrough behavior of inventive combiadsorbents A1 and A2 versus the noninventive agglomerates B1.
   A first series of tests is used to investigate the breakthrough behavior in relation to NH₃. In this context, the following experimental parameters hold:
   c (in, NH₃)=1000 ppm
   breakthrough value or criterion (NH₃)=25 ppm
   v (in)=10 cm/s
   relative humidity (RH)=70%
   temperature T=23° C.
   sample height h=20 mm; sample diameter dₛₐₘₚₗₑ=50 mm

TABLE 2
Measured results of breakthrough
behavior

| | | | Breakthrough |
|---|---|---|---|
| | Fraction | Pressure drop | time NH₃ |
| | [mm] | [Pa/cm] at 0.2 m/s | [min] |
| Combiadsorbent | 1.25 to 2.5 | 32 | 6 |
| (A1) (with MOFs) | | | |
| Adsorbent (B1) | 1.25 to 2.5 | 32 | 0.5 |

The breakthrough behavior of inventive combiadsorbent A1 was further investigated in relation to C₇H₈ versus the noninventive adsorbent B1.
The settings for the measurements were as follows:
C (in, C₇H₈)=1000 ppm
breakthrough value/criterion (C₇H₈)=25 ppm
v(in)=10 cm/s
relative humidity RH=70%
temperature T=23° C.
sample height h=20 mm; sample diameter
dₛₐₘₚₗₑ=50 mm
The measured results are summarized below in table 3.

TABLE 3
C₇H₈ breakthrough curves

| | | | Breakthrough |
|---|---|---|---|
| | Fraction | Pressure drop | time C₇H₈ |
| | [mm] | [Pa/cm] at 0.2 m/s | [min] |
| Combiadsorbent | 1.25 to 2.5 | 32 | 155 |
| (A2) | | | |
| Combiadsorbent | 1.25 to 2.5 | 32 | 146 |
| (B1) | | | |

The results shown above in respect of break-through behavior demonstrate the significant improvement in the adsorption properties of inventive composite adsorbents compared with prior art agglomerates.

In effect, the adsorptive systems of the present invention exhibit distinctly improved properties over the prior art with regard to breakthrough behavior and with regard to adsorption properties in relation to toxic substances.

1-15. (canceled)

16. A process for producing agglomerate-based adsorptive systems comprising a multiplicity of adsorbent particles,
wherein the adsorbent particles are fixed on a binder carrier and are bound together via the binder carrier, resulting in the adsorptive system on the basis of an agglomerate of adsorbent particles, wherein the binder carrier forms at least one core of the respective adsorptive system and wherein particles of a first particulate adsorption material A and particles of a second particulate adsorption material B of a single adsorptive system are each disposed or lodged at at least one core in the form of binder carrier, and
wherein the adsorbent particles include a first particulate adsorption material A and a second particulate adsorption material B other than the first particulate adsorption material A, wherein the first particulate adsorption material A and the second particulate adsorption material B have mutually different particle diameters, wherein the first particulate adsorption material A has a larger average particle diameter D50 than the second particulate adsorption material B and wherein the ratio of the average particle diameter D50 of the first particulate adsorption material A to the average particle diameter D50 of the second particulate adsorption material B is at least 1.1:1,
wherein the process comprises the following steps:
a) initially a first particulate adsorption material A on the one hand and particles of a binder carrier 2 on the other are brought into contact or are mixed,
b) the resulting mixture is subsequently heated to temperatures above the melting or softening temperature of the binder carrier and the first particulate adsorption material A is made to adhere on the binder carrier 2 or fixed to the binder carrier to obtain in this way intermediates which include the first particulate adsorption material A and the binder carrier,
c) optionally, the resulting intermediates are then cooled to temperatures below the melting or softening temperature of the binder of the binder carrier,
d) then the second particulate adsorption material B is added to the intermediate products or is brought into contact or is mixed with the intermediates,
e) optionally, the resulting mixture is subsequently heated again to temperatures above the melting or softening temperature of the binder of the binder carrier,
f) the second particulate adsorption material B is made to adhere on the binder carrier or is fixed to the binder carrier to obtain in this way products which include the first particulate adsorption material A and the second particulate adsorption material B and the binder carrier 2, and
g) finally, the resulting products are cooled down to temperatures below the melting or softening temperature of the binder of binder carrier to obtain discrete agglomerate-based adsorptive systems.

17. The process as claimed in claim 16, wherein the adsorptive systems resulting in step g) are processed in a subsequent step h) into a molded part.

18. The process as claimed in claim 16, wherein the adsorptive systems resulting in step g) are processed in a subsequent step h) into a molded part by compression molding.

19. The process as claimed in claim 16, wherein the adsorptive systems resulting in step g) are processed in a subsequent step h) into a molded part by compression molding, wherein the processing into molded parts is effected by heating to temperatures below the melting or softening temperature of the binder carrier.

20. An agglomerate-based adsorptive system comprising a multiplicity of adsorbent particles, wherein the adsorptive system is obtained by a process as claimed in claim 16.

21. The adsorptive system as claimed in claim 20,
wherein the adsorbent particles are fixed on a binder carrier and are bound together via the binder carrier, resulting in the adsorptive system on the basis of an agglomerate of adsorbent particles, wherein the binder carrier forms at least one core of the respective adsorptive system and wherein particles of a first particulate adsorption material A and particles of a second particulate adsorption material B of a single adsorptive system are each disposed or lodged at at least one core in the form of binder carrier, and
wherein the adsorbent particles include a first particulate adsorption material A and a second particulate adsorption material B other than the first particulate adsorption material A, wherein the first particulate adsorption material A and the second particulate adsorption material B have mutually different particle diameters, wherein the first particulate adsorption material A has a larger average particle diameter D50 than the second particulate adsorption material B and wherein the ratio of the average particle diameter D50 of the first particulate adsorption material A to the average particle diameter D50 of the second particulate adsorption material B is at least 1.1:1.

22. The adsorptive system as claimed in claim 21, wherein the particles of the first particulate adsorption material A are fixed on the binder carrier and are bound together via the binder carrier, resulting in the adsorptive system on the basis of an agglomerate of adsorbent particles, wherein free regions of the binder carrier which remain between the particles of the first particulate adsorption material A are endowed with particles of the second particulate adsorption material B.

23. The adsorptive system as claimed in claim 21, wherein the average particle diameter D50 of the first particulate adsorption material A is by at least a factor of 5 greater than the average particle diameter D50 of the second particulate adsorption material B.

24. The adsorptive system as claimed in claim 21, wherein the ratio of the average particle diameter D50 of the first particulate adsorption material A to the average particle diameter D50 of the second particulate adsorption material B is at least at least 10:1.

25. The adsorptive system as claimed in claim 21, wherein the ratio of the average particle diameter D50 of the first particulate adsorption material A to the average particle diameter D50 of the second particulate adsorption material B is in the range from 5:1 to 200:1.

26. The adsorptive system as claimed in claim 21, wherein the first particulate adsorption material A has an average particle diameter D50 in the range from 0.05 to 4 mm.

27. The adsorptive system as claimed in claim 21, wherein the second particulate adsorption material B has an average particle diameter D50 in the range from 0.005 to 1.5 mm.

28. The adsorptive system as claimed in claim 20, wherein the particle-forming material of the first particulate adsorption material A and of the second particulate adsorption material B, independently of each other, is selected from the group of
(i) activated carbon;
(ii) zeolites;
(iii) molecular sieves;
(iv) metal oxides and metals;
(v) ion-exchanger resins;
(vi) inorganic oxides;
(vii) porous organic polymers, porous organic-inorganic hybrid polymers and organometallic scaffolding materials;
(viii) mineral pellets;
(ix) clathrates; and
(x) mixtures and combinations thereof

29. The adsorptive system as claimed in claim 20, wherein the particle-forming material of the first particulate adsorption material A and the particle-forming material of the second particulate adsorption material B, independently of each other, is formed from activated carbon.

30. The adsorptive system as claimed in claim 21, wherein the first particulate adsorption material A and the second particulate adsorption material B each comprise identical particle-forming materials, with the proviso that the first particulate adsorption material A and the second particulate adsorption material B differ in at least one physicochemical parameter, wherein the physicochemical parameter is selected from the group of (i) specific surface area; (ii) pore volume; (iii) porosity; (iv) pore distribution; (v) impregnation; (vi) particle shape.

31. The adsorptive system as claimed in claim 21, wherein the first particulate adsorption material A and the second particulate adsorption material B each comprise different particle-forming materials, wherein the first particulate adsorption material A and the second particulate adsorption material B further differ in at least one physicochemical parameter, wherein the physicochemical parameter is selected from the group of (i) specific surface area; (ii) pore volume; (iii) porosity; (iv) pore distribution; (v) impregnation; (vi) particle shape.

32. An agglomerate-based adsorptive system comprising a multiplicity of adsorbent particles,
wherein the adsorbent particles are fixed on a binder carrier and are bound together via the binder carrier, resulting in the adsorptive system on the basis of an agglomerate of adsorbent particles, wherein the binder carrier forms at least one core of the respective adsorptive system and wherein particles of a first particulate adsorption material A and particles of a second particulate adsorption material B of a single adsorptive system are each disposed or lodged at at least one core in the form of binder carrier, and
wherein the adsorbent particles include a first particulate adsorption material A and a second particulate adsorption material B other than the first particulate adsorption material A, wherein the first particulate adsorption material A and the second particulate adsorption material B have mutually different particle diameters, wherein the first particulate adsorption material A has a larger average particle diameter D50 than the second particulate adsorption material B and wherein the ratio of the average particle diameter D50 of the first particulate adsorption material A to the average particle diameter D50 of the second particulate adsorption material B is at least 1.1:1.

33. An agglomerate-based adsorptive system comprising a multiplicity of adsorbent particles,
wherein the adsorbent particles are fixed on a binder carrier and are bound together via the binder carrier, resulting in the adsorptive system on the basis of an agglomerate of adsorbent particles, wherein the binder carrier forms at least one core of the respective adsorptive system and wherein particles of a first particulate adsorption material A and particles of a second particulate adsorption material B of a single adsorptive system are each disposed or lodged at at least one core in the form of binder carrier, and
wherein the adsorbent particles include a first particulate adsorption material A and a second particulate adsorption material B other than the first particulate adsorption material A, wherein the first particulate adsorption material A and the second particulate adsorption material B have mutually different particle diameters, wherein the first particulate adsorption material A has a larger average particle diameter D50 than the second particulate adsorption material B, wherein the ratio of the average particle diameter D50 of the first particulate adsorption material A to the average particle diameter D50 of the second particulate adsorption material B is in the range from 5:1 to 200:1,
wherein the particles of the first particulate adsorption material A are fixed on the binder carrier and are bound together via the binder carrier, resulting in the adsorptive system on the basis of an agglomerate of adsorbent particles, wherein free regions of the binder carrier which remain between the particles of the first particulate adsorption material A are endowed with particles of the second particulate adsorption material B.

34. An adsorption filter comprising a multiplicity of agglomerate-based adsorptive systems as defined in claim 20.

35. An adsorptive molded part constructed from a multiplicity of adsorptive systems as defined in claim 20.

36. A filter comprising an adsorptive molded part as claimed in claim 35.
